(19) United States
(12) Patent Application Publication
(10) Pub. No.: US 2025/0234878 A1
(43) Pub. Date: Jul. 24, 2025

(54) A METHOD OF PRODUCING MINERALISED, LACTOSE-REDUCED MILK PRODUCT AND THE MILK PRODUCT RESULTING FROM THE METHOD

(71) Applicant: ARLA FOODS AMBA, Viby J (DK)

(72) Inventors: Valentin RAUH, Viby J (DK); Michael CRAFACK, Viby J (DK); Shyam Krishna SUWAL, Viby J (DK); Saeed Rahimi YAZDI, Viby J (DK)

(21) Appl. No.: 18/698,587

(22) PCT Filed: Oct. 6, 2022
(86) PCT No.: PCT/EP2022/077842

§ 371 Date: Apr. 4, 2024

(30) Foreign Application Priority Data
Oct. 6, 2021 (EP) 21201319.7

(51) Int. Cl. A23C 9/144; A23C 9/142

(52) U.S. Cl. CPC A23C 9/144; A23C 9/1422

(57) ABSTRACT

The invention relates to a method of preparing a lactose-reduced milk product by e.g. ultrafiltration which method involves recovery of at least some of the mineral from the ultrafiltration permeate by electrodialysis.

### FIELD OF THE INVENTION

The invention relates to a method of preparing a lactose-reduced milk product by e.g. ultrafiltration which method involves recovery of at least some of the mineral from the ultrafiltration permeate by electrodialysis.

### BACKGROUND OF THE INVENTION

Lactose-reduced milk products have long been available to persons suffering from lactose-intolerance and have enabled them to enjoy the nutritional benefits of dairy products without symptoms caused by lactose. Lactose-reduction involving membrane filtration is often applied and makes it possible to retain milk protein and fat in the final milk product while lactose is washed out of milk and ends up in the UF permeate. Unfortunately, the UF-based lactose-reduction also removes other components such as minerals from the milk products and therefore provides end-products with reduced minerals (nutritional) and organoleptic properties compared to normal (lactose containing) milk.

In the prior art this problem has e.g. been addressed by WO03094623 which discloses a process for producing lactose-free milk products. The process of the invention is characterized by the steps of subjecting a milk product to ultrafiltration (UF), nanofiltration (NF) and concentration by reverse osmosis, followed by the addition of salt to the UF retentate.

CN109744316 discloses a method for preparing de-lactose milk based on microfiltration, ultrafiltration, electrodialysis and nanofiltration. Firstly, the milk protein of milk is intercepted by microfiltration and ultrafiltration. For most components, the permeated solution is an aqueous solution containing lactose and inorganic salts. After the inorganic salts are recovered by electrodialysis, a desalination solution containing lactose and a small amount of inorganic salts is obtained. The desalination solution is then nanofiltration separated to retain lactose. That is, the lactose removal is completed, and the components other than lactose are recombined through spray drying to obtain a lactose-free milk powder.

US 2020/008438 A1 discloses a method of separating components from milk and utilizing the separated components to form blended dairy compositions. The present invention relates to nutritional milk compositions and products which are designed to include per serving size a specified percentage range of one or more components separated from milk. The compositions of the present invention can optionally include non-essential but nutritionally functional components.

US 2019/223461 A1 discloses methods for preparing dairy compositions using an electrochemical separation process in combination with at least one of the methods ultrafiltration, microfiltration, and nanofiltration. Additional methods for preparing the dairy compositions can further include a reverse osmosis step and/or a forward osmosis step.

WO 2022/015868 discloses methods for preparing dairy compositions utilize an electrodialysis apparatus to separate a feed stream into a lactose stream and a mineral stream. The feed stream can be a UF permeate fraction, a NF retentate fraction, or a RO retentate fraction. The brine input to the electrodialysis apparatus can be a milk mineral stream.

### SUMMARY OF THE INVENTION

The inventors have found that, surprisingly, it is technically feasible to use electrodialysis (ED) for recapturing minerals that are lost during the lactose-reduction and particularly during lactose-reduction by e.g. ultrafiltration. In the dairy industry, electrodialysis is traditionally used to demineralise whey to make it suitable for infant nutrition. However, in the present invention electrodialysis is used to recapture minerals that are lost in the side stream during the lactose-reduction and the ED is preferably operated to transfer the minerals directly back to liquid streams that originate from the initial lactose-containing milk feed and that are recombined to form an improved lactose-reduced milk product.

Additionally, the method improves the utilization of the milk feed and reduces the amount of the feed that goes into undesired side-streams that are irrelevant for the final product. The method furthermore reduces or even removes the need for using external water during the production of the lactose-reduced milk product as the water of the milk feed can be recovered and returned to the final lactose-reduced milk product. It is often advantageous to use as much as possible of the milk feed in the final lactose-reduced product to maximize the product yield. The method of the present invention is therefore more cost-effective and efficient than prior art method wherein minerals are recovered and returned to low lactose milk products.

Thus, an aspect of the invention pertains to a method of producing a lactose-reduced milk product, the method comprising the steps of:
a) subjecting a milk feed to ultrafiltration (UF) to provide:
   a UF retentate enriched with respect to milk protein, and
   a UF permeate enriched with respect to lactose,
b) performing a first electrodialysis process using a diluate stream which comprises or even consists of:
   a portion of the UF permeate, and/or
   a first lactose-enriched retentate derived from a portion of the UF permeate
and using a concentrate stream which comprises, or even consists of:
   a lactose-reduced liquid derived from a portion of the UF permeate,
to provide a first mineral-enriched ED concentrate stream,
c) optionally, performing one or more additional electrodialysis process(es) using diluate stream(s) comprising, or even consisting of:
   a portion of the UF permeate, and/or
   an additional lactose-enriched retentate derived from a portion of the UF permeate, and using a concentrate stream comprising or even consisting of:
      the first mineral-enriched concentrate stream obtained from step b), and/or
      a further lactose-reduced liquid derived from a portion of the UF permeate, to provide one or more additional mineral-enriched ED concentrate stream(s),
d) preparing a lactose-reduced milk intermediate liquid by combining:
   a portion of the UF retentate, or a protein concentrate thereof,
   one or more of:
   at least the minerals of the first mineralised ED concentrate stream of step b), and/or
   at least the minerals of one or more of the additional mineral-enriched ED concentrated stream(s) of step c)
   optionally, one or more additional lactose-reduced liquids, preferably obtained during the method, and
   optionally, further ingredients.

The inventors have furthermore observed that a portion of the water of the diluent stream (typically about 8% of the initial volume) normally migrates to the concentrate stream during the ED process. This is sometimes seen as a disadvantage in traditional ED processing but is an advantage in the present invention where the additional water in the mineralised ED concentrate preferably contributes to the total weight, and hence yield of, the final lactose-reduced milk product and improves the utilization of the original milk feed and reduces the volume of side stream. Without being bound by theory, the inventors believe that this water transport phenomenon is due to so-called electro-osmosis.

A further advantage of the invention is that it simplifies the processing of the milk feed as the minerals lost to the UF permeate are recovered directly into liquid that originate from the milk feed and can be used as such in the final product.

Another aspect of the invention pertains to a lactose-reduced milk product obtainable by the method of the invention.

Yet an aspect of the invention pertains to the use of electrodialysis for transferring minerals from a first liquid stream containing dairy minerals to a second liquid stream containing dairy minerals, wherein the first liquid stream is used as diluate stream for the ED and the second liquid stream is used as concentrate stream for the ED, preferably to mineralised the second liquid stream before it is used as ingredient for food production.

### BRIEF DESCRIPTION OF THE FIGURES

FIG. 1 shows a schematic illustration of configuration of ED stack used in Example 1; X+ represents cations and Y-represents anions. Dotted rectangle represents a cell pair.

FIG. 2 shows changes in the electrical conductivity of diluate (2.5 Kg) and concentrate (2.5 Kg) streams during the ED process of Example 1.

FIG. 3 shows the changes in pH of diluate (NFR, 2.5 Kg) and concentrate (NFP, 2.5 Kg) streams during ED process of Example 1.

FIG. 4 shows changes in the electrical conductivity of diluate (2 Kg) and concentrate (6 Kg) streams during the ED process of Example 2.

FIG. 5 shows the changes in pH of diluate (NFR, 2 Kg) and concentrate (NFP, 6 Kg) streams during ED process of Example 2.

FIG. 6 shows changes in the electrical conductivity of diluate (2.5 Kg) and concentrate (2.5 Kg) streams during the ED process of Example 3.

FIGS. 7-10 show four exemplary embodiments of the method of the invention.

### DETAILED DESCRIPTION

An aspect of the invention pertains to a method of producing a lactose-reduced milk product, the method comprising the steps of:
a) subjecting a milk feed to ultrafiltration (UF) to provide:
   a UF retentate enriched with respect to milk protein, and
   a UF permeate enriched with respect to lactose,
b) performing a first electrodialysis process using a diluate stream which comprises or even consists of:
   a portion of the UF permeate, and/or
   a first lactose-enriched retentate derived from a portion of the UF permeate
and using a concentrate stream which comprises, or even consists of:
   a lactose-reduced liquid derived from a portion of the UF permeate,
to provide a first mineral-enriched ED concentrate stream,
c) optionally, performing one or more additional electrodialysis process(es) using diluate stream(s) comprising, or even consisting of:
   a portion of the UF permeate, and/or
   an additional lactose-enriched retentate derived from a portion of the UF permeate,
and using a concentrate stream comprising or even consisting of:
   the first mineral-enriched concentrate stream obtained from step b), and/or
   a further lactose-reduced liquid derived from a portion of the UF permeate, to provide one or more additional mineral-enriched ED concentrate stream(s),
d) preparing a lactose-reduced milk intermediate liquid by combining:
   a portion of the UF retentate, or a protein concentrate thereof,
   one or more of:
      at least the minerals of the first mineralised ED concentrate stream of step b), and/or
      at least the minerals of one or more of the additional mineral-enriched ED concentrated stream(s) of step c)
   optionally, one or more additional lactose-reduced liquids, preferably obtained during the method, and
   optionally, further ingredients.

In the context of the present invention, the term “lactose-reduced milk product” pertains to a liquid milk product having a lactose content of at most 3.8% w/w, more preferably at most 1% w/w, even more preferably at most 0.1% w/w, and most preferably at most 0.01% w/w.

In the context of the present invention, the term “milk feed” pertains to the milk-derived liquid feed that is subjected to the ultrafiltration of step a) and preferably contains at least 1% w/w milk protein and at least 0.2% w/w lactose. By milk-derived, it is meant that at least substantially all of the solids of the milk feed originates from milk. The milk feed may e.g. be liquid milk as such or a concentrate or dilution of liquid milk.

The term “ultrafiltration” (UF) is well-known to the skilled person and describes membrane filtration of a liquid feed to obtain a retentate (the portion of the feed that is retained by the ultrafiltration membrane) and a permeate (the portion of the feed that permeates through the UF membrane). The ultrafiltration is preferably implemented as tangential flow ultrafiltration, also referred to as cross-flow ultrafiltration. The ultrafiltration is preferably performed using a membrane that allows for the passage of lactose but retains the milk proteins.

The ultrafiltration operation of step a) results in a UF retentate and a UF permeate. The UF retentate is enriched with milk proteins from the milk feed but has a lower lactose content relative to total solids than the milk feed. The UF permeate contains much less protein relative to total solids than the milk feed but has a lactose content relative to total solids that is higher than the milk feed. Additionally, the UF permeate contains a portion of the minerals that were present in the milk feed.

The term “nanofiltration” (NF) is well-known in the art and refers to a membrane process that retains smaller molecules than UF filtration but allows for the permeation of the smallest solids. Nanofiltration in the present context involves the use of a membrane that retains substantially all lactose but allows for the passage of at least CI⁻, Na⁺, and K⁺. Suitable membranes for nanofiltration preferably have a nominal molecular weight cut-off in the range of 150-500 Dalton, and most preferably in the range of 150-300 Dalton.

The term “reverse osmosis” (RO) is well-known in the art and refers to a membrane process that retains substantially all solids including the small monovalent ions but allows for the passage of water.

The term “electrodialysis” (ED) is well-known to the person skilled in the art and is e.g. described in “Membrane filtration and related molecular separation technologies”, published by APV Systems, 2000, ISBN 87-88016 757 and in “Ion exchange membranes Fundamentals and Applications”, Yoshinobu Tanaka, 2nd edition, Elsevier, 2015, ISBN: 978-0-444-63319-4, and “Ion Exchange Membranes Preparation, characterisation, modification and application”, Toshikatsu Sata, The Royal Society of Chemistry, 2004, ISBN 0-85404-590-2 which are incorporated herein for all purposes.

Briefly described, ED typically employs transport of ions from a feed solution (the diluate stream) through ion-exchange membranes into one or more neighbouring liquid solutions (the concentrate stream) under the influence of an applied electric field. This is done in a configuration called an electrodialysis cell. The cell typically comprises of a dilute compartment (for the diluate stream which is to donate minerals) defined by an anion exchange membrane and a cation exchange membrane and placed adjacent to one or more “concentrate compartments” (for the concentrate stream which is to receive minerals). The electric field attracts cations of the diluate stream to the negative electrode and anions to the positive electrode and at least the smaller cations and anions are capable of permeating through the cation exchange membrane and the anion exchange membrane, respectively. In this way, charged molecular species are moved from the diluate stream into the concentrate stream.

In the context of the present invention, the term “concentrate stream” used as such pertains to the initial concentrate stream that is subjected to the ED of step b). The initial concentrate stream is mineralised during the ED processing, and depending on the actual design of the ED set-up, there may furthermore be intermediate concentrate streams between ED stacks arranged in series or during ED performed in batch mode. The final mineralised product that is obtained by step b is referred to as the “first mineral-enriched ED concentrate stream”.

In the context of the present invention, the term “diluate stream” used as such pertains to the initial diluate stream that is subjected to the ED of step b. The initial diluate stream is demineralised during the ED processing and depending on the actual design of the ED set-up, there may furthermore be intermediate diluate streams between ED stacks arranged in series or during ED performed in batch mode. The final demineralised product that is obtained by step b is referred to as the “first demineralised ED diluate stream”.

In the context of the present invention, the term “a portion of” in relation to a given composition means at least subset of the given composition is used, said subset having the same chemical composition as the given composition, but the term also includes using the complete given composition, unless it is evident that this is not feasible.

In the context of the present invention, the term “first lactose-enriched retentate derived from a portion of the UF permeate” pertains to a retentate, preferably a nanofiltration (NF) retentate or a reverse osmosis (RO) retentate, obtained by further processing a portion of the UF permeate. Preferably at least the lactose, more preferably substantially all the solids, and most preferably substantially all matter of the “first lactose-enriched retentate is derived from a portion of the UF permeate” originate from the UF permeate.

Preferably the “first lactose-enriched retentate derived from a portion of the UF permeate” comprises or even consists of one or more of:
an NF retentate of a portion of the UF permeate, or
an RO retentate of a portion of the UF permeate.

The “first lactose-enriched retentate derived from a portion of the UF permeate” preferably has a content of lactose relative to total solids which is higher than the content of lactose relative to total solids of the UF permeate.

In the context of the present invention, the term “lactose-reduced liquid derived from a portion of the UF permeate” pertains to a liquid which has a lower concentration of lactose than the UF permeate and wherein at least substantially all the lactose, more preferably substantially all the solids, and most preferably substantially all matter of the “lactose-reduced liquid derived from a portion of the UF permeate” originates from the UF permeate. The “lactose-reduced liquid derived from a portion of the UF permeate” preferably comprises of even consist of an NF permeate or RO permeate of the UF permeate, or alternative an NF permeate or RO permeate of the ED-treated UF permeate.

In the context of the present invention, the term “substantially all” means at least 95% w/w, more preferably at least 97% w/w, even more preferably at least 99% w/w, and most preferably 100% w/w.

In the context of the present invention, the term “protein concentrate” of a protein-containing liquid pertains to the result of concentrating the liquid by one or more of evaporation, ultrafiltration, nanofiltration, or reverse osmosis without altering the relative composition of the protein fraction.

In the context of the present invention the term, “dilution” used in the context of a protein-containing liquid pertains to the liquid obtained by dilution the protein-containing liquid with a protein-free aqueous liquid, such as e.g. water, NF permeate of milk or whey, or RO permeate of milk or whey.

Preferably, the method furthermore comprises a step e) of further processing the lactose-reduced milk intermediate liquid of step d), preferably by one or more of:
i) lactose hydrolysis,
ii) homogenization,
iii) heat-treatment,
iv) drying, and
v) packaging.

The lactose-reduced milk product may therefore be the intermediate liquid obtained from step d) or alternative, but typically preferred, the product resulting from step e).

Preferred exemplary embodiments have been illustrated in FIGS. 7-10.

FIG. 7 illustrates a method wherein skim milk is ultrafiltered to produce UF retentate and UF permeate. The UF permeate is then nanofiltered to produce NF retentate and NF permeate. The NF retentate is fed to ED unit as diluate and NF permeate as concentrate. The minerals present in the NF retentate are transferred to NF permeate. This will produce demineralised NF retentate and mineralised NF permeate. The mineralised NF permeate then is mixed with the UF retentate to produce mineralised lactose reduced milk product.

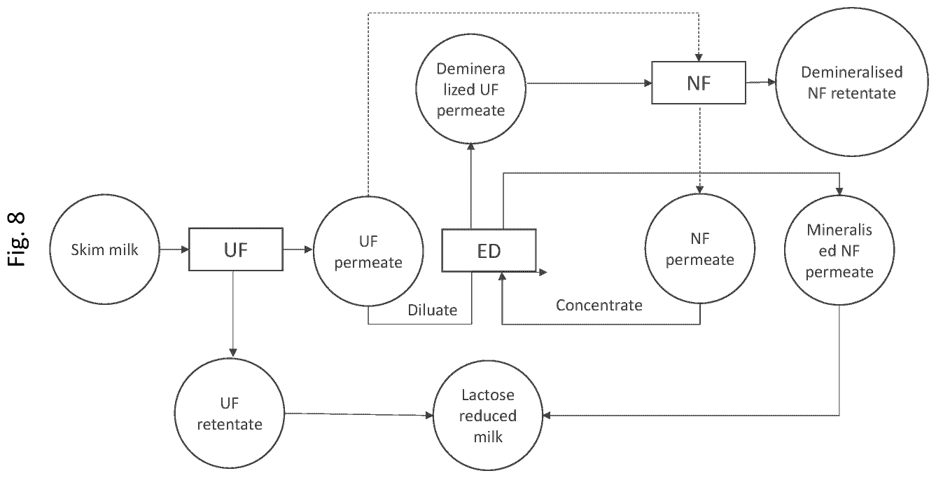

FIG. 8 illustrates a method wherein skim milk is ultrafiltered to produce UF retentate and UF permeate. A portion of the UF permeate is then nanofiltered to produce a portion of NF retentate and a portion of NF permeate as shown by the process flow using dotted line. The remaining UF permeate is then fed to ED unit as diluate and the NF permeate as concentrate. The minerals present in the UF permeate are transferred to NF permeate. The demineralised UF permeate is then nanofiltered to produce NF permeate which is also fed to ED as concentrate. This will produce the demineralised NF retentate and the mineralised NF permeate. The mineralised NF permeate fraction then is mixed with the UF retentate to produce mineralised lactose reduced milk product.

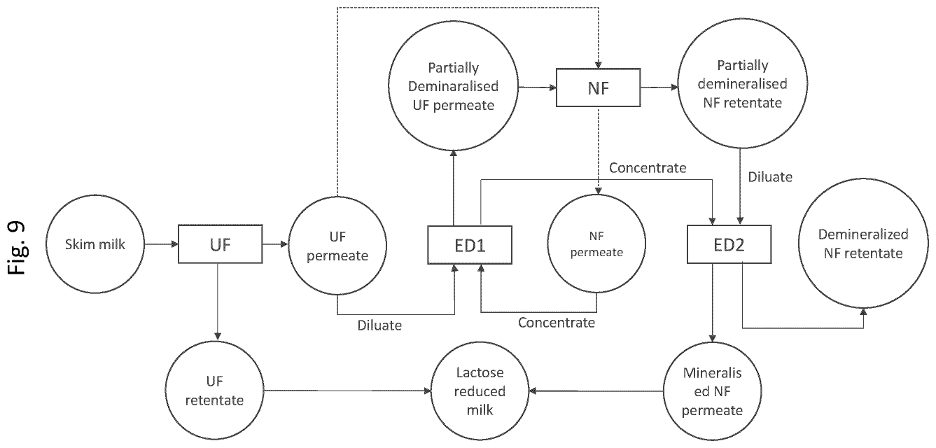

FIG. 9 illustrates a method wherein the UF permeate is partially demineralised using the method explained in FIG. 8 followed by additional NF and ED treatments.

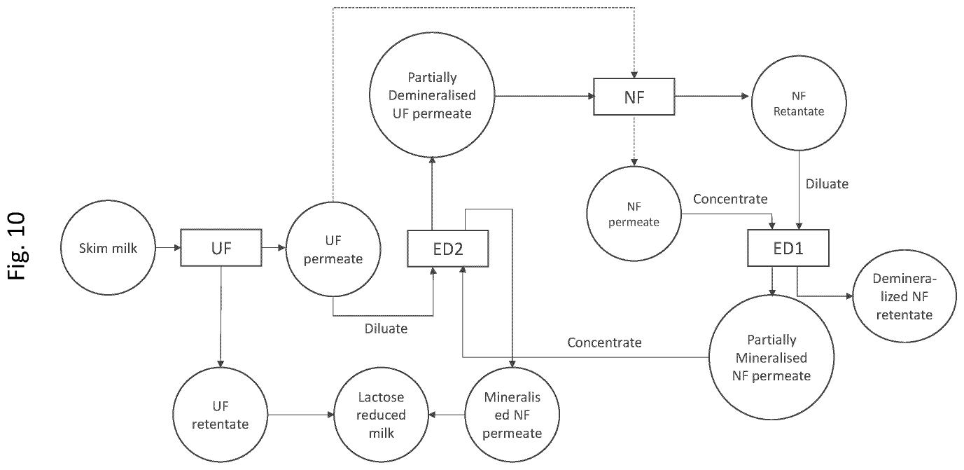

FIG. 10 illustrates a method wherein NF retentate is partially demineralised using the method explained in FIG. 7 followed by an additional ED and NF treatments of UF permeate.

As said, step a) involves subjecting a milk feed to ultrafiltration (UF) to provide:
a UF retentate comprising milk protein, and
a UF permeate comprising lactose.

In some preferred embodiments of the invention, the milk feed is selected from the group consisting of skimmed milk, semi-skimmed milk, whole milk, a mixture thereof, a protein concentrate thereof, or a dilution thereof.

The milk feed preferably has a fat content of at most 4% w/w, more preferably at most 1% w/w, even more preferably 0.5% w/w, and most preferably 0.1% w/w.

Skimmed milk, i.e. milk has a fat content of at most 0.2% w/w, or a protein concentrate or diluate therefore is a particularly preferred milk feed.

The milk feed preferably has a lactose content of 1-15%, more preferably 2-10% w/w, even more preferably 3-8% w/w, and most preferably 4-6% w/w.

The milk feed preferably has a protein content of 1-15%, more preferably 2-10% w/w, even more preferably 3-8% w/w, and most preferably 3-4% w/w.

The milk feed preferably has a non-protein nitrogen content of 0.01-0.06%, more preferably 0.015-0.05% w/w, even more preferably 0.02-0.04% w/w, and most preferably 0.02-0.03% w/w.

The term “non-protein nitrogen” (NPN) pertains to small molecules that contain nitrogen but are not true protein. Non-limiting examples of such small molecules are e.g. urea, creatine, creatinine, nitrate, nitrite, ammonia, free amino acids and small peptide fragments. The content of NPN is measured as described in Example 1.

The pH of the milk feed may vary depending on the source and prior processing of milk feed. However, preferably the milk feed has a pH in the range of 6-8, more preferably 6.0-8.0, even more preferably 6.2-7.8, and most preferably 6.4-7.2.

In some preferred embodiments of the invention, the milk feed has one or more of, more preferably two or more of, and most preferably all of:
a sodium content in the range of 0.02-0.06% w/w, and most preferably 0.03-0.05% w/w,
a potassium content in the range of 0.15-0.19% w/w, and most preferably 0.16-0.18% w/w,
a magnesium content in the range of 0.009-0.016% w/w, and most preferably 0.010-0.014% w/w
a calcium content in the range of 0.10-0.17% w/w, and most preferably 0.11-0.15% w/w,
a chloride content in the range of 0.07-0.15% w/w, and most preferably 0.08-0.14% w/w,
a phosphorus content in the range of 0.08-0.15% w/w, and most preferably 0.09-0.13% w/w, and
a non-protein-nitrogen content in the range of 0.010-0.05% w/w, and most preferably 0.02-0.04% w/w.

In some preferred embodiments of the invention, the milk feed has one or more of, more preferably two or more of, and most preferably all of:
a protein content in the range of 3-5% w/w, and most preferably 3.3-4.0% w/w,
a fat content in the range of 0.001-0.5% w/w, and most preferably 0.01-0.3% w/w,
an ash content in the range of 0.5-1.2% w/w, and most preferably 0.6-0.1.0% w/w,
a lactose content in the range of 3-7% w/w, and most preferably 4.0-5.0% w/w,
a carbohydrate content in the range of 3-7% w/w, and most preferably 4.0-5.0% w/w,
a pH in the range of 6.2-7.8, and most preferably 6.4-7.2.

The milk feed is preferably derived from mammal milk, and more preferably from ruminant milk. Even more preferably, the milk feed is derived from milk from one or more of cow, sheep, goat, buffalo, camel, reindeer and/or llama. A milk feed derived from cow milk is presently preferred, and particularly a skim milk derived from cow milk.

The ultrafiltration of step a) is preferably performed using a membrane that allows for the passage of lactose but retains the milk protein alpha-lactalbumin and preferably all milk proteins.

In some preferred embodiments of the invention, the UF membrane has nominal pore size in the range of 1000-50000 Da, more preferably 2000-40000 Da, even more preferably 3000-30000 Da, and most preferably 4000-30000 Da.

A wide range of concentration factors may be used in relation to the UF of step a). In some preferred embodiments of the invention, the UF step is performed with a concentration factor of 1.2-20, more preferably 1.5-10, even more preferably 1.7-8, and more preferably 1.8-5.

The ultrafiltration of step a) may additionally involve diafiltration. Thus in some preferred embodiments of the invention, the UF step involves diafiltration, preferably using a lactose-reduced liquid derived from a portion of the UF permeate or from the milk feed as diluent.

The ultrafiltration of step a) is preferably operated at a temperature in the range of 0-60 degrees C., more preferably 2-50 degrees C., even more preferably 4-20 degrees C., and most preferably 5-15 degrees C.

The inventors have observed that performing the ultrafiltration at temperatures below 20 degrees C., e.g. in combination with cold-storage of the milk feed prior to the ultrafiltration, results in higher loss of minerals to the UF permeate and increases the necessity for recovering at least some of the lost minerals.

The UF of step a) provides a UF retentate enriched with respect to milk protein, and the UF retentate furthermore contains some lactose and minerals, and small charged molecules including non-protein nitrogen (NPN).

The UF retentate is enriched with respect to milk protein in the sense that the protein content of the UF retentate relative to total solids is higher than the protein content of the milk feed relative to total solids.

It is often preferred that the UF retentate has, and the UF of step a) is operated to provide a UF retentate having, a protein content that is at least 20% higher than the protein content of the milk feed, more preferably at least 50% higher, even more preferably at least 70% higher, and most preferably at least 80% higher.

Preferably, the UF retentate has, and the UF of step a) is operated to provide, a protein content that is 20-500% higher than the protein content of the milk feed, more preferably 50-400% higher, even more preferably 70-300% higher, and most preferably 100-250% higher.

In some preferred embodiments of the invention, the UF retentate has, and the UF of step a) is operated to provide a UF retentate having, one or more of, more preferably two or more of, and most preferably all of:
a sodium content in the range of 0.01-0.08% w/w, and most preferably 0.03-0.06% w/w,
a potassium content in the range of 0.07-0.3% w/w, and most preferably 0.13-0.25% w/w,
a magnesium content in the range of 0.007-0.03% w/w, and most preferably 0.012-0.024% w/w
a calcium content in the range of 0.09-0.4% w/w, and most preferably 0.15-0.3% w/w,
a chloride content in the range of 0.03-0.15% w/w, and most preferably 0.06-0.12% w/w,
a phosphorus content in the range of 0.06-0.26% w/w, and most preferably 0.11-0.21% w/w, and
a non-protein-nitrogen content in the range of 0.01-0.04% w/w, and most preferably 0.015-0.03% w/w.

In some preferred embodiments of the invention the UF retentate has, and the UF of step a) is operated to provide a UF retentate having, one or more of, more preferably two or more of, and most preferably all of:
a protein content in the range of 3-10% w/w, and most preferably 3-8.0% w/w,
a fat content in the range of 0.001-2% w/w, and most preferably 0.1-1.0% w/w,
an ash content in the range of 0.5-1.5% w/w, and most preferably 0.6-1.3% w/w,
a lactose content in the range of 3-7% w/w, and most preferably 4-5% w/w,
a carbohydrate content in the range of 3-7% w/w, and most preferably 4-5% w/w,
a pH in the range of 6.2-7.8, and most preferably 6.4-7.2.

The UF of step a) is operated to provide an UF permeate enriched with respect to lactose, meaning that the lactose content of the UF permeate relative to total solids is larger than the lactose content of the milk feed relative to total solids.

The UF permeate is typically substantially free of protein but has an absolute lactose content close to the level of the milk feed if the UF step has been operated without diafiltration. If the ultrafiltration of step a) is operated with diafiltration, it is preferred to recover the combined pool of permeate which will contain a lower concentration of lactose than the milk feed due to the diafiltration.

In some preferred embodiments of the invention, the UF permeate has, and the UF of step a) is operated to provide a UF permeate having, one or more of, more preferably two or more of, and most preferably all of:
a sodium content in the range of 0.01-0.06% w/w, and most preferably 0.02-0.05% w/w,
a potassium content in the range of 0.05-0.2% w/w, and most preferably 0.8-0.16% w/w,
a magnesium content in the range of 0.002-0.02% w/w, and most preferably 0.004-0.01% w/w
a calcium content in the range of 0.01-0.05% w/w, and most preferably 0.02-0.04% w/w,
a chloride content in the range of 0.03-0.15% w/w, and most preferably 0.06-0.12% w/w,
a phosphorus content in the range of 0.01-0.06% w/w, and most preferably 0.02-0.05% w/w, and
a non-protein-nitrogen content in the range of 0.009-0.04% w/w, and most preferably 0.015-0.03% w/w.

In some preferred embodiments of the invention, the UF permeate has, and the UF of step a) is operated to provide a UF permeate having, one or more of, more preferably two or more of, and most preferably all of:
a protein content in the range of 0-0.5% w/w, and most preferably 0-0.3% w/w,
a fat content in the range of 0-0.2% w/w, and most preferably 0-0.1% w/w,
an ash content in the range of 0.1-0.5% w/w, and most preferably 0.15-0.4% w/w,
a lactose content in the range of 2-7% w/w, and most preferably 3-5% w/w,
a carbohydrate content in the range of 2-7% w/w, and most preferably 3-5% w/w,
a pH in the range of 6.2-7.8, and most preferably 6.4-7.2.

As mentioned above, step b) involves performing a first electrodialysis process using a diluate stream which comprises or even consists of:
a portion of the UF permeate, and/or
a first lactose-enriched retentate derived from a portion of the UF permeate, and using a concentrate stream which comprises, or even consists of:
a lactose-reduced liquid derived from a portion of the UF permeate,
   to provide a first mineral-enriched ED concentrate stream.

The ED process of step b), also referred to as the first ED process to signal that the method of the invention may contain further ED processes, may be implemented in a number of different ways, including a single ED stack, or multiple ED stacks. If multiple ED stacks are used they may be arranged in series or in parallel or combinations thereof. Additionally, the ED process may be operated in batch mode or it may be operated continuously. If operated continuously, it is often preferred to use multiple ED stacks and preferably to arrange at least some of them in series.

In the context of the present invention, when a composition is “derived from a portion of the UF permeate” or “derived from the UF permeate” then substantially all of the solids of the composition originate from the UF permeate. Preferably, at least 95% w/w of the solids of the composition originate from the UF permeate, more preferably at least 97% w/w, even more preferably at least 97% w/w and most preferably 100% w/w.

It is furthermore often preferred that substantially all of the water of a composition which is “derived from the UF permeate” or “derived from a portion of the UF permeate” originates from the UF permeate. Preferably at least 95% w/w of the water of the composition originate from the UF permeate, more preferably at least 97% w/w, even more preferably at least 99% w/w and most preferably 100% w/w.

Preferably, the sum of
the UF permeate, and
lactose-enriched retentate(s) derived from a portion of the UF permeate,
   makes up least 50% w/w of the diluate stream of step b), more preferably at least 70% w/w, even more preferably at least 80% w/w, and most preferably at least 90% w/w.

Even more preferred, the sum of
the UF permeate, and
lactose-enriched retentate(s) derived from a portion of the UF permeate,
   makes up least 95% w/w of the diluate stream of step b), more preferably at least 97% w/w, even more preferably at least 99% w/w, and most preferably 100% w/w.

In some preferred embodiments of the invention, the first lactose-enriched retentate derived from a portion of the UF permeate is an NF retentate or an RO retentate, and preferably an NF retentate or an RO retentate of the UF permeate.

The pH of the diluate stream of step b) may vary and is typically close to the pH of the milk feed of more acidic. Preferably, the pH of the diluate stream of step b) is in the range of 5-8, more preferably 5.2-7.6, even more preferably 5.4-7.0, and most preferably 5.8-6.6.

In some preferred embodiments of the present invention, the diluate stream of step b) has a conductivity of at least 2 mS/cm, more preferably at least 3 mS/cm, and most preferably at least 4 mS/cm. Preferably, the diluate stream of step b) has a conductivity of 2-15 mS/cm more preferably 2-12 mS/cm, and most preferably 4-10 mS/cm.

In other preferred embodiments of the present invention, the diluate stream of step b) has a conductivity of at least 5 mS/cm, more preferably at least 6 mS/cm, and most preferably at least 7 mS/cm. Preferably, the diluate stream of step b) has a conductivity of 5-15 mS/cm, more preferably 6-15 mS/cm, and most preferably 7-15 mS/cm.

In some preferred embodiments of the invention, the diluate stream of step b) is prepared to have one or more of, more preferably two or more of, and most preferably all of:
a calcium content of at least 100 mg/kg, and most preferably at least 500 mg/kg,
a phosphorus content of at least 100 mg/kg, and most preferably at least 200 mg/kg,
a potassium content of at least 700 mg/kg, and most preferably at least 800 mg/kg,
a sodium content of at least 200 mg/kg, and most preferably at least 300 mg/kg,
a magnesium content of at least 15 mg/kg, and most preferably at least 20 mg/kg
a chloride content of at least 500 mg/kg, and most preferably at least 600 mg/kg.

Preferably, the diluate stream of step b) is prepared to have one or more of, more preferably two or more of, and most preferably all of:
a calcium content in the range of 100-2500 mg/kg, and most preferably 500-2500 mg/kg,
a phosphorus content in the range of 100-3000 mg/kg, and most preferably 200-3000 mg/kg,
a potassium content in the range of 700-7000 mg/kg, and most preferably 800-7000 mg/kg,
a sodium content in the range of 200-1500 mg/kg, and most preferably 300-1500 mg/kg,
a magnesium content in the range of 15-500 mg/kg, and most preferably 20-500 mg/kg
a chloride content in the range of 500-2000 mg/kg, and most preferably 600-2000 mg/kg.

In some preferred embodiments of the invention, the diluate stream of step b) is prepared to have one or more of, more preferably two or more of, and most preferably all of:
a protein content of at least 0.1 g/100 g, and most preferably at least 0.3 g/100 g,
a fat content in the range of 0-0.2 g/100 g, and most preferably 0-0.1 g/100 g,
an ash content of at least 0.18 g/100 g, and most preferably at least 0.20 g/100 g,
a non-protein-nitrogen content of at least 0.015 g/100 g, and most preferably at least 0.020 g/100 g.
a lactose content of at least 2 g/100 g, and most preferably at least 3 g/100 g,
a carbohydrate content of at least 2 g/100 g, and most preferably at least 3 g/100 g.

Preferably, the diluate stream of step b) is prepared to have one or more of, more preferably two or more of, and most preferably all of:
a protein content in the range of 0-0.8 g/100 g, and most preferably 0-0.6 g/100 g,
a fat content in the range of 0-0.2 g/100 g, and most preferably 0-0.1 g/100 g,
an ash content in the range of 0.18-2 g/100 g, and most preferably 0.20-2 g/100 g,
a non-protein-nitrogen content in the range of 0.015-0.10 g/100 g, and most preferably 0.020-0.10 g/100 g.
a lactose content in the range of 2-25 g/100 g, and most preferably 3-25 g/100 g,
a carbohydrate content in the range of 2-25 g/100 g, and most preferably 3-25 g/100 g.

The concentrate stream of step b) has a lower content of lactose relative to total solids than the UF permeate and is often and preferably made up of water and solids that originate from the UF permeate.

In some preferred embodiments of the invention, the concentrate stream of step b) comprises or even consists of an NF permeate or an RO permeate derived from of the UF permeate, preferably an NF permeate or an RO permeate of the UF permeate.

In some preferred embodiments of the invention, the lactose-reduced liquid(s) derived from a portion of the UF permeate makes up at least 50% w/w of the concentrate stream of step b), more preferably at least 70% w/w, even more preferably at least 80% w/w, and most preferably at least 90% w/w.

It is often preferred that lactose-reduced liquid(s) derived from a portion of the UF permeate make up at least 95% w/w of the concentrate stream of step b), more preferably at least 97% w/w, even more preferably at least 99% w/w, and most preferably 100% w/w.

While the pH of the concentrate stream of step b) may vary, it is preferred that it has a pH in the range of 6-8, more preferably 6.0-8.0, even more preferably 6.2-7.8, and most preferably 6.4-7.2.

The inventors have found that it often is advantageous to operate with, and therefore also prepare, a concentrate stream that has a certain conductivity. In some preferred embodiments of the present invention the concentrate stream of step b) has a conductivity of at least 1 mS/cm, more preferably at least 2 mS/cm, and most preferably at least 3 mS/cm. Preferably, the concentrate stream of step b) has a conductivity of 0.5-8 mS/cm, more preferably 1-7 mS/cm, and most preferably 2-6 mS/cm.

In some preferred embodiments of the invention, the concentrate stream of step b) is prepared to have one or more of, more preferably two or more of, and most preferably all of:
a potassium content of at least 100 mg/kg, and most preferably at least 200 mg/kg,
a sodium content of at least 50 mg/kg, and most preferably at least 70 mg/kg,
a chloride content of at least 150 mg/kg, and most preferably at least 270 mg/kg.

Preferably, the concentrate stream of step b) is prepared to have one or more of, more preferably two or more of, and most preferably all of:
a potassium content in the range of 100-1500 mg/kg, and most preferably 200-1000 mg/kg,
a sodium content in the range of 50-500 mg/kg, and most preferably 70-1000 mg/kg,
a chloride content in the range of 150-2500 mg/kg, and most preferably 270-2000 mg/kg.

In some preferred embodiments of the invention, the concentrate stream of step b) is prepared to have one or more of, more preferably two or more of, and most preferably all of:
a protein content of at most 0.2 g/100 g, and most preferably at most 0.1 g/100 g,
a fat content of at most 0.2 g/100 g, and most preferably at most 0.1 g/100 g,
an ash content of at least 0.05 g/100 g, and most preferably at least 0.10 g/100 g,
a non-protein-nitrogen content of at least 0.005 g/100 g, and most preferably at least 0.008 g/100 g.

Preferably, the concentrate stream of step b) is prepared to have one or more of, more preferably two or more of, and most preferably all of:
a protein content of at most 0.2 g/100 g, and most preferably at most 0.1 g/100 g,
a fat content of at most 0.2 g/100 g, and most preferably at most 0.1 g/100 g,
an ash content in the range of 0.05-0-5 g/100 g, and most preferably 0.10-0.4 g/100 g,
a non-protein-nitrogen content in the range of 0.005-0.03 g/100 g, and most preferably 0.010-0.02 g/100 g.

The ED described herein preferably employs electrolyte streams contacting the electrodes of the ED stack. The purpose of the electrolyte streams is to carry electrical currents towards the electrodes and constantly rinse the electrode where electrochemical reactions take place. Preferably, the electrode streams contain no or only traces of proteins. The electrolyte streams typically comprises one or more food-grade inorganic salts dissolved in water. Useful examples of such salts are e.g. NaCl, Na2SO4, and/or NaNO3.

The ED of step b) is preferably operated at a temperature in the range of 0-60 degrees C., more preferably 2-50 degrees C., even more preferably 4-20 degrees C., and most preferably 5-15 degrees C.

This means that the temperature of one or more of the diluate and concentrate, and preferably also the electrolyte, preferably is maintained in one of the above-mentioned ranges during the ED of step b).

More preferably, the temperature of both the diluate and concentrate, and preferably also the electrolyte, is maintained in one of the above-mentioned ranges during the ED of step b).

In some preferred embodiments of the invention, the electrodialysis of step b) is operated with a voltage per membrane pair in the range of 0.2-5 V, more preferably 0.4-3 V, even more preferably 0.6-2 V; and most preferably 0.8-1.8 V.

The ED can be operated in different modes of power supply, such as constant DC voltage or constant current. Preferably, the power supply of the ED of step b) involves or essentially consists of constant DC voltage or of constant DC voltage in combination with pulsed electric fields or polarity reversal.

When the ED is operated in combination with pulsed electric fields, the power is switched off or the polarity is reversed in pulses, preferably in an equal interval of time (e.g. 2 s on & 0.2 s off) or polarity reversal i.e. anode being cathode and cathode being anode (e.g. 2 s normal & 0.1 s polarity reversal). Both pulsed and polarity reversal modes seem to reduce membrane fouling as they minimises concentration polarisation at the membrane-solution interfaces.

The membranes in ED process are ion-exchange membranes and require both anion exchange membranes (AEM) and cation exchange membranes (CEM). Suitable ED membranes are well-known in the art and non-limiting examples are the anion-exchange membrane RALEX® AMH-PES (MEGA a.s., the Czech Republic) and the cation-exchange membrane RALEX® CMH-PES (MEGA a.s., the Czech Republic)).

The ED stack used for step b) may be configured in a number of different ways. The inventors have found that the membrane configuration of CEM-AEM-CEM-AEM-CEM . . . (Starting from anode side (left) to cathode side (right)) allows some of the minerals from the electrolyte solution to migrate to the concentrate side which is not desirable, as it leads to contamination the end-product.

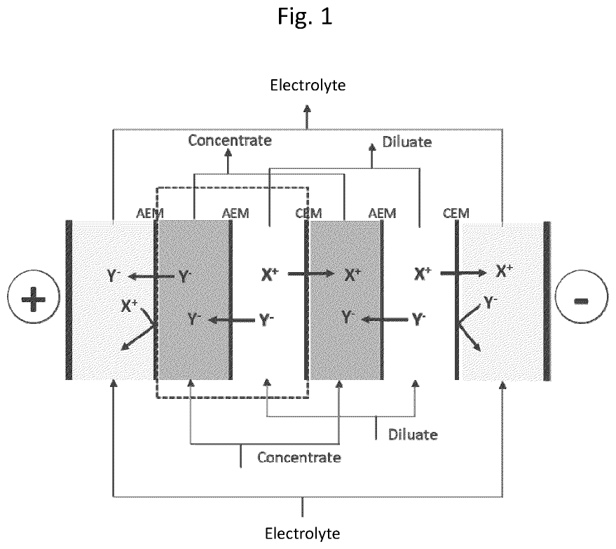

The inventors have found that the ED stack configuration AEM-[AEM-CEM-]ₙ AEM-CEM (see FIG. 1) or AEM-CEM[-AEM-CEM]ₙ-CEM, wherein n is at least 1, is advantageous as it reduces or even avoid the risk of minerals moving from the electrolyte to the concentrate stream. The configuration AEM-[AEM-CEM-]ₙ AEM-CEM is particularly preferred.

In some preferred embodiments of the invention, the ED stack used in step b) contains at least 5 cell pairs, more preferably at least 10 cell pairs, even more preferably at least 30 cell pairs and most preferably at least 100 cell pairs.

Preferably, the ED system used in step b) contains 5-1000 cell pairs, more preferably 10-800 cell pairs, even more preferably 30-600 cell pairs and most preferably 100-500 cell pairs.

The inventors have found that a low number of cell pairs result in a higher loss of minerals to the electrolyte stream, which is not desirable.

In some preferred embodiments of the invention, the electrodialysis of step b) is operated to obtain a demineralisation rate of at least 60%, more preferably at least 80%, even more preferably at least 90%, and most preferably at least 95%. The demineralisation rate is determined as outlined Example 1.

Alternatively but also preferred, the electrodialysis of step b) may be operated to obtain a demineralisation rate of 60-95%, more preferably 65-90%, even more preferably 70-88%, and most preferably 75-85%. The inventors have found these embodiments advantageous as they reduced or even prevent significant changes in the pH of the concentrate stream during the ED process.

The pH of the first mineral-enriched ED concentrate stream of step b) may vary and is typically close to the pH of the milk feed of more acidic. Preferably, the pH of the first mineral-enriched ED concentrate stream of step b) is in the range of 5-8, more preferably 5.2-7.6, even more preferably 5.4-7.2, and most preferably 6.5-7.0.

It is preferred that the ED process is operated to cause as little pH change in the concentrate stream as possible. The ED process of step b) is preferably operated to cause a pH change in the first mineral-enriched ED concentrate stream relative to the concentrate stream used initially of at most 0.5 pH units, more preferably at most 0.4 pH unit, even more preferred at most 0.2 pH unit, and most preferably at most 0.1 pH unit.

The ED process will increase the conductivity of the first mineral-enriched ED concentrate stream of step b) relative to the concentrate stream that was used initially. In some preferred embodiments of the present invention, the first mineral-enriched ED concentrate stream of step b) has a conductivity of at least 2 mS/cm, more preferably at least 3 mS/cm, and most preferably at least 4 mS/cm. Preferably, first mineral-enriched ED concentrate stream of step b) has a conductivity of 2-15 mS/cm, more preferably 2-12 mS/cm, and most preferably 4-10 mS/cm.

Even higher conductivities are often preferred. In some preferred embodiments of the present invention, the first mineral-enriched ED concentrate stream of step b) has a conductivity of at least 5 mS/cm, more preferably at least 6 mS/cm, and most preferably at least 7 mS/cm. Preferably, the first mineral-enriched ED concentrate stream of step b) has a conductivity of 5-15 mS/cm, more preferably 6-15 mS/cm, and most preferably 7-15 mS/cm.

It is preferred that the ED process is operated to provide a first mineral-enriched ED concentrate stream that has a conductivity that is at least 1 mS/cm higher than the concentrate stream used initially, more preferably at least 2 mS/cm higher, even more preferably at least 3 mS/cm higher, and most preferably at least 4 mS/cm higher.

In some embodiments the ED process of step b) is operated to provide a first mineral-enriched ED concentrate stream that has a conductivity that is 1-15 mS/cm higher than the concentrate stream used initially, more preferably 2-14 mS/cm higher, even more preferably 3-12 mS/cm higher, and most preferably 4-10 mS/cm higher.

In some preferred embodiments of the invention the first mineral-enriched ED concentrate stream of step b) is prepared to have one or more of, more preferably two or more of, and most preferably all of:
a calcium content of at least 100 mg/kg, and most preferably at least 500 mg/kg,
a phosphorus content of at least 100 mg/kg, and most preferably at least 200 mg/kg,
a potassium content of at least 700 mg/kg, and most preferably at least 800 mg/kg,
a sodium content of at least 200 mg/kg, and most preferably at least 300 mg/kg,
a magnesium content of at least 15 mg/kg, and most preferably at least 20 mg/kg
a chloride content of at least 500 mg/kg, and most preferably at least 600 mg/kg.

Preferably, the first mineral-enriched ED concentrate stream of step b) is prepared to have one or more of, more preferably two or more of, and most preferably all of:
a calcium content in the range of 100-2500 mg/kg, and most preferably 500-2500 mg/kg,
a phosphorus content in the range of 100-3000 mg/kg, and most preferably 200-3000 mg/kg,
a potassium content in the range of 700-7000 mg/kg, and most preferably 800-7000 mg/kg,
a sodium content in the range of 200-1500 mg/kg, and most preferably 300-1500 mg/kg,
a magnesium content in the range of 15-500 mg/kg, and most preferably 20-500 mg/kg
a chloride content in the range of 500-2000 mg/kg, and most preferably 600-2000 mg/kg.

In some preferred embodiments of the invention, the first mineral-enriched ED concentrate stream of step b) is prepared to have one or more of, more preferably two or more of, and most preferably all of:
a protein content of at most 0.2 g/100 g, and most preferably at most 0.1 g/100 g,
a fat content of at most 0.2 g/100 g, and most preferably at most 0.1 g/100 g,
an ash content of at least 0.18 g/100 g, and most preferably at least 0.20 g/100 g,
a non-protein-nitrogen content of at least 0.015 g/100 g, and most preferably at least 0.020 g/100 g.
a lactose content of at most 0.2 g/100 g, and most preferably at most 0.1 g/100 g.

Preferably, the first mineral-enriched ED concentrate stream of step b) is prepared to have one or more of, more preferably two or more of, and most preferably all of:
a protein content of at most 0.2 g/100 g, and most preferably at most 0.1 g/100 g,
a fat content of at most 0.2 g/100 g, and most preferably at most 0.1 g/100 g,
an ash content in the range of 0.18-2 g/100 g, and most preferably 0.20-2 g/100 g,
a non-protein-nitrogen content in the range of 0.015-0.10 g/100 g, and most preferably 0.020-0.10 g/100 g,
a lactose content of at most 0.2 g/100 g, and most preferably at most 0.1 g/100 g.

Step c) is optional, but if it used, it involves performing one or more additional electrodialysis process(s) using diluate stream(s) comprising, or even consisting of:
a portion of the UF permeate, and/or
an additional lactose-enriched retentate derived from a portion of the UF permeate
   and using a concentrate stream comprising or even consisting of:
the first mineral-enriched concentrate stream obtained from step b), and/or
a further lactose-reduced liquid derived from a portion of the UF permeate,
   to provide one or more additional mineral-enriched ED concentrate stream(s),

Features, embodiments, and preferences relating to the implementation of the ED of step b) applies equally to the ED of step c).

Features and preferences described in the context of the diluate stream of step b) equally apply to the diluate stream(s) of step c).

The additional lactose-enriched retentate derived from a portion of the UF permeate is a “lactose-enriched retentate derived from a portion of the UF permeate” as described herein.

Preferably, the sum of
the portion pf UF permeate, and
lactose-enriched retentate(s) derived from a portion of the UF permeate,
   makes up at least 50% w/w of the diluate stream of step c), more preferably at least 70% w/w, even more preferably at least 80% w/w, and most preferably at least 90% w/w.

Even more preferred, the sum of
the UF permeate, and
lactose-enriched retentate(s) derived from a portion of the UF permeate,
   makes up at least 95% w/w of the diluate stream of step c), more preferably at least 97% w/w, even more preferably at least 99% w/w, and most preferably 100% w/w.

Features and preferences described in the context of the concentrate stream of step b) equally apply to the concentrate stream(s) of step c).

The further lactose-reduced liquid derived from a portion of the UF permeate is a “lactose-reduced liquid derived from a portion of the UF permeate” as described herein.

In some preferred embodiments of the present invention, the sum of
the first mineral-enriched concentrate stream obtained from step b), and
a lactose-reduced liquid(s) derived from a portion of the UF permeate,
   makes up at least 50% w/w of the concentrate stream of step c), more preferably at least 70% w/w, even more preferably at least 80% w/w, and most preferably at least 90% w/w.

It is often preferred that the sum of
the first mineral-enriched concentrate stream obtained from step b), and
a lactose-reduced liquid(s) derived from a portion of the UF permeate,
   makes up at least 95% w/w of the concentrate stream of step c), more preferably at least 97% w/w, even more preferably at least 99% w/w, and most preferably 100% w/w.

Features and preferences described in the context of the first mineral-enriched ED concentrate stream of step b) equally apply to the one or more additional mineral-enriched ED concentrate stream(s) of step c).

Step d) involves preparing a lactose-reduced milk intermediate liquid, preferably by combining:
a portion of the UF retentate, or a protein concentrate or dilution of the portion,
one or more of:
at least the minerals of the first mineralised ED concentrate stream of step b), and/or
at least the minerals of one or more of the additional mineral-enriched ED concentrated stream(s) of step c)
optionally, one or more additional lactose-reduced liquid(s), preferably obtained during the method, and
optionally, further ingredients.

The lactose-reduced milk intermediate liquid is preferably prepared to obtain one or more of the features described below.

In some preferred embodiments of the invention, at least 80% w/w of the solids of the lactose-reduced milk intermediate liquid of step d) originate from the milk feed, more preferably at least 90% w/w, even more preferably at least 95% w/w, and most preferably at least 99% w/w.

It is often preferred that all solids of the lactose-reduced milk intermediate liquid originate from the milk feed.

In some preferred embodiments of the invention, at least 80% w/w of the protein of the lactose-reduced milk intermediate liquid of step d) originate from the milk feed, more preferably at least 90% w/w, even more preferably at least 95% w/w, and most preferably at least 99% w/w.

It is often preferred that all protein of the lactose-reduced milk intermediate liquid originate from the milk feed.

In some preferred embodiments of the invention, at least 80% w/w of the mineral of the lactose-reduced milk intermediate liquid of step d) originate from the milk feed, more preferably at least 90% w/w, even more preferably at least 95% w/w, and most preferably at least 99% w/w.

It is often preferred that all mineral of the lactose-reduced milk intermediate liquid originate from the milk feed.

In some preferred embodiments of the invention, at least 80% w/w of the water of the lactose-reduced milk intermediate liquid of step d) originate from the milk feed, more preferably at least 90% w/w, even more preferably at least 95% w/w, and most preferably at least 99% w/w.

It is often preferred that all water of the lactose-reduced milk intermediate liquid originate from the milk feed.

In some preferred embodiments of the invention, at least 80% w/w of the matter of the lactose-reduced milk intermediate liquid of step d) originate from the milk feed, more preferably at least 90% w/w, even more preferably at least 95% w/w, and most preferably at least 99% w/w.

It is often preferred that all water of the lactose-reduced milk intermediate liquid originate from the milk feed.

The fat content of the lactose-reduced milk intermediate liquid may be tailored to the desired use of the liquid. However, preferably the lactose-reduced milk intermediate liquid of step d) has a fat content of at most 4% w/w, more preferably at most 1% w/w, even more preferably at most 0.5% w/w, and most preferably at most 0.1% w/w.

Preferably, the lactose-reduced milk intermediate liquid of step d) has a lactose content of at most 3.8% w/w, more preferably 1% w/w, even more preferably at most 0.1% w/w, and most preferably at most 0.01% w/w.

It is often preferred that the lactose-reduced milk intermediate liquid contains at least some lactose. Lactose can be hydrolysed into glucose and galactose which, in small amounts, add a subtle, milk-like sweetness to product. Thus, in some preferred embodiments of the invention, the lactose-reduced milk intermediate liquid of step d) has a content of lactose of 0.1-3.8%, more preferably 0.5-3.8% w/w, even more preferably 1-3.8% w/w, and most preferably 2-3.8% w/w.

In some preferred embodiments of the invention, the lactose-reduced milk intermediate liquid of step d) has a combined content of lactose, glucose and galactose of 0-3.8%, more preferably 0.5-3.8% w/w, even more preferably 1-3.8% w/w, and most preferably 2-3.8% w/w.

The carbohydrate content of the lactose-reduced milk intermediate liquid may be adjusted to provide the final milk product with a suitable sweetness and calorie density. Preferably, the lactose-reduced milk intermediate liquid of step d) has a carbohydrate content of 0-12%, more preferably 0.1-10% w/w, even more preferably 1-5% w/w, and most preferably 2.0-3.8% w/w.

Preferably, the lactose-reduced milk intermediate liquid of step d) has a protein content of 1-15%, more preferably 2-10% w/w, even more preferably 3-8% w/w, and most preferably 3-4% w/w.

Preferably, the lactose-reduced milk intermediate liquid of step d) has a non-protein nitrogen content of 0.015-0.06%, more preferably 0.015-0.05% w/w, even more preferably 0.02-0.04% w/w, and most preferably 0.02-0.03% w/w.

Preferably, the lactose-reduced milk intermediate liquid of step d) has a pH in the range of 6-8, more preferably 6.0-8.0, even more preferably 6.2-7.8, and most preferably 6.4-7.5.

In some preferred embodiments of the invention, the lactose-reduced milk intermediate liquid of step d) comprises the UF retentate, or a protein concentrate thereof, in an amount of 30-80% w/w, more preferably 40-75% w/w, even more preferably 45-70% w/w, and most preferably 50-65% w/w.

In some preferred embodiments of the invention, the lactose-reduced milk intermediate liquid of step d) comprises the UF retentate in an amount of 30-80% w/w, more preferably 40-75% w/w, even more preferably 45-70% w/w, and most preferably 50-65% w/w.

It is furthermore preferred that the lactose-reduced milk intermediate liquid of step d) comprises mineralised ED concentrate(s) of step b) and/or c) in an amount of 5-40% w/w, more preferably 10-40% w/w, even more preferably 10-35% w/w, and most preferably 12-35% w/w.

The mineral of the lactose-reduced milk intermediate liquid is often primarily provided by the added UF retentate and the added mineralised ED concentrate stream of step b) and/or step c). It is often preferred that the added UF retentate and the added mineralised ED concentrate stream of step b) and/or step c) contribute with at least 80% w/w of the mineral (measured as the ash value) of the lactose-reduced milk intermediate liquid, more preferably at least 90% w/w, even more preferably at least 95% w/w, and most preferably approx. 100% w/w of the of the mineral of the lactose-reduced milk intermediate liquid.

The protein of the lactose-reduced milk intermediate liquid is often primarily provided by the added UF retentate. It is often preferred that the added UF retentate contributes with at least 80% w/w of the protein of the lactose-reduced milk intermediate liquid, more preferably at least 90% w/w, even more preferably at least 95% w/w, and most preferably approx. 100% w/w of the of the protein of the lactose-reduced milk intermediate liquid.

The protein of the lactose-reduced milk intermediate liquid is often primarily provided by the added UF retentate. It is often preferred that the added UF retentate contributes with at least 80% w/w of the protein of the lactose-reduced milk intermediate liquid, more preferably at least 90% w/w, even more preferably at least 95% w/w, and most preferably approx. 100% w/w of the of the protein of the lactose-reduced milk intermediate liquid.

The lactose of the lactose-reduced milk intermediate liquid is often primarily provided by the added UF retentate. It is often preferred that the added UF retentate contributes with at least 80% w/w of the lactose of the lactose-reduced milk intermediate liquid, more preferably at least 90% w/w, even more preferably at least 95% w/w, and most preferably approx. 100% w/w of the of the lactose of the lactose-reduced milk intermediate liquid.

The carbohydrate of the lactose-reduced milk intermediate liquid is often primarily provided by the added UF retentate. It is often preferred that the added UF retentate contributes with at least 80% w/w of the lactose of the lactose-reduced milk intermediate liquid, more preferably at least 90% w/w, even more preferably at least 95% w/w, and most preferably approx. 100% w/w of the of the carbohydrate of the lactose-reduced milk intermediate liquid.

The solids of the lactose-reduced milk intermediate liquid is often primarily provided by the added UF retentate and the added mineralised ED concentrate stream of step b) and/or step c). It is often preferred that the added UF retentate and the added mineralised ED concentrate stream of step b) and/or step c) contribute with at least 80% w/w of the solids of the lactose-reduced milk intermediate liquid, more preferably at least 90% w/w, even more preferably at least 95% w/w, and most preferably approx. 100% w/w of the of the solids of the lactose-reduced milk intermediate liquid.

The fat of the lactose-reduced milk intermediate liquid is often primarily provided by the added UF retentate. It is often preferred that the added UF retentate contributes with at least 80% w/w of the fat of the lactose-reduced milk intermediate liquid, more preferably at least 90% w/w, even more preferably at least 95% w/w, and most preferably approx. 100% w/w of the of the fat of the lactose-reduced milk intermediate liquid.

In some preferred embodiments of the present invention, the lactose-reduced milk intermediate liquid contains additional ingredients such as e.g. one or more of a stabilizer, a sweetener, a flavour, a colouring agent.

However, in other preferred embodiments of the present invention, the lactose-reduced milk intermediate liquid consists essentially of ingredients that originate from the milk feed.

In some preferred embodiments of the present invention, the lactose-reduced milk intermediate liquid contains one or more of, and preferably all of:
At least 80% of the water of the milk feed, more preferably at least 90% w/w, and most preferably at least 95% w/w of the water of the milk feed,
At least 90% of the protein of the milk feed, more preferably at least 95% w/w, and most preferably at least 98% w/w of the protein of the milk feed,
At least 80% of the mineral of the milk feed, more preferably at least 90% w/w, and most preferably at least 95% w/w of the mineral of the milk feed,
At most 70% of the lactose of the milk feed, more preferably at most 50% w/w, and most preferably at most 20% w/w of the lactose of the milk feed.

In some preferred embodiments of the invention the method furthermore comprises a step e) of further processing the lactose-reduced milk intermediate liquid of step d), preferably by one or more of:
i) lactose hydrolysis,
ii) homogenization,
iii) heat-treatment,
iv) drying, and
v) packaging.

The lactose hydrolysis of substep i) typically involves contacting or mixing the lactose-reduced milk intermediate liquid with an enzyme capable of hydrolysing lactose into glucose and galactose. Such enzymes are well-known in the art and are typically referred to as lactases or beta-galactosidases. The enzymes at typically added in small amounts that do not change to overall composition of the lactose-reduced milk intermediate liquid except with respect to its content of lactose, glucose and galactose. Some beta-galactosidases also have transgalactosylation activity and are capable of forming galacto-oligosaccharides.

In some preferred embodiments of the invention, the lactose hydrolysis of step i) involves addition of sterile beta-galactosidase preparation to a sterile lactose-reduced milk intermediate liquid or to the sterile container in which sterile lactose-reduced milk intermediate liquid is added.

Alternatively, the lactose hydrolysis of step i) may take place prior to a packaging step or even during the packaging.

The homogenization of sub-step ii) is typically relevant when additional fat or stabilizing agents are added to the lactose-reduced milk intermediate liquid. Processing by homogenisation is well-known in the art and typically involves homogenisation in one or two stages with a total pressure drop of 20-500 bar, and most preferably 100-300 bar.

The heat-treatment of sub-step iii) preferably heats the lactose-reduced milk intermediate liquid to a temperature of at least 65 degrees C. for duration for at least pasteurizing it.

For long shelf-life products and products suitable for ambient storage it is furthermore preferred to heat the lactose-reduced milk intermediate liquid to a temperature of at least 100 degrees C. for a duration sufficient to sterilize it.

In some preferred embodiments of the invention, the heat-treatment of sub-step. iii) involves heating the lactose-reduced milk intermediate liquid to a temperature of at least 140 degrees C. for a duration sufficient to sterilize it.

Heat-sterilization is preferably performed by heating the lactose-reduced milk intermediate liquid to a temperature of least 140-180 degrees C., and more preferably in the range of 140-160 degrees C. for a duration sufficient to sterilize it.

Heat-sterilization is preferably a UHT treatment and preferably involves heating the lactose-reduced milk intermediate liquid to a temperature of 140-148 degrees C. for a duration in the range of 1-10 seconds, most preferably 142-146 degrees C. for a duration in the range of 2-8 seconds.

Alternatively, but also preferred, the heat-sterilization may involve heating the lactose-reduced milk intermediate liquid to a temperature of 147-180 degrees C. for a duration in the range of 0.05-5 seconds, most preferably 150-160 degrees C. for a duration in the range of 0.05-0.5 seconds.

In some embodiments of the invention the heat-sterilization is performed by indirect heating, e.g. using a plate heat exchanger and/or a tubular heat exchanger.

In some preferred embodiments of the invention the heat-sterilization is performed by direct heating and preferably by steam injection or steam infusion.

The final lactose-reduced milk product is therefore preferably sterile and has preferably been heat-sterilized.

The drying of sub-step iv) is only relevant when the lactose-reduced milk product is a lactose-reduced milk powder. Sub-step iv) preferably involves spray-drying and may furthermore involve concentration of the solids of liquid to be dried prior to spray-drying. The concentration of solids preferably involves concentration by evaporation and/or reverse osmosis.

However, in some preferred embodiments of the invention, the method does not involve sub-step iv), e.g. where the final lactose-reduced milk product is a liquid product.

The packaging of sub-step v) involve transferred the product to be packaged into a suitable container.

In some preferred embodiments of the invention, sub-step v) involves aseptic packaging of a sterilized product in sterile containers and subsequently sealing the containers. This is e.g. preferred for production of long shelf-life variants of the liquid lactose-reduced milk product.

Suitable containers are e.g. bottles, cartons, bricks, pouches and/or bags.

In some preferred embodiments of the invention step e) comprises subjecting the lactose-reduced milk intermediate liquid of step d) to:
i) lactose hydrolysis
iii) heat-treatment, and
v) packaging, but not to drying.

In other preferred embodiments of the invention, step e) comprises subjecting the lactose-reduced milk intermediate liquid of step d) to:
i) lactose hydrolysis
iii) heat-treatment,
iv) drying, and
v) packaging.

In some particularly preferred embodiments of the invention, the method comprises the steps of:
a) subjecting a milk feed to ultrafiltration (UF) to provide:
   a UF retentate enriched with respect to milk protein, and
   a UF permeate enriched with respect to lactose, wherein the UF step is performed with a concentration factor of 1.2-20,
b) performing a first electrodialysis process using a diluate stream which comprises or even consists of:
   an NF retentate of a portion of the UF permeate
and using a concentrate stream which comprises, or even consists of:
   an NF permeate of a portion of the UF permeate,
to provide a first mineral-enriched ED concentrate stream,
wherein the concentrate stream of step b) has a conductivity of at least 1 mS/cm, and the diluate stream of step b) has a conductivity of at least 2 mS/cm,
and wherein the electrodialysis of step b) is operated to obtain a demineralisation rate of at least 60%,
d) preparing a lactose-reduced milk intermediate liquid by combining:
   the UF retentate,
   the first mineralised ED concentrate stream of step b), and
   optionally, further ingredients,
wherein the lactose-reduced milk intermediate liquid of step d) comprises:
   the UF retentate in an amount of 30-80% w/w, more preferably 40-75% w/w, even more preferably 45-70% w/w, and most preferably 50-65% w/w, and
   the mineralised ED concentrate of step b) in an amount of 5-40% w/w, more preferably 10-40% w/w, even more preferably 10-35% w/w, and most preferably 12-35% w/w.

In other particularly preferred embodiments of the invention, the method comprises the steps of:
a) subjecting a milk feed to ultrafiltration (UF) to provide:
   a UF retentate enriched with respect to milk protein, and
   a UF permeate enriched with respect to lactose,
Wherein the UF step is performed with a concentration factor of 1.2-20
b) performing a first electrodialysis process using a diluate stream which comprises or even consists of:
   a portion of the UF permeate, and/or
   a first lactose-enriched retentate derived from a portion of the UF permeate
and using a concentrate stream which comprises, or even consists of:
   a lactose-reduced liquid derived from a portion of the UF permeate,
to provide a first mineral-enriched ED concentrate stream,
wherein the concentrate stream of step b) has a conductivity of at least 1 mS/cm, and the diluate stream of step b) has a conductivity of at least 2 mS/cm,
and wherein the electrodialysis of step b) is operated to obtain a demineralisation rate of at least 60%,
d) preparing a lactose-reduced milk intermediate liquid by combining:
   a portion of the UF retentate, or a protein concentrate thereof,
   at least the minerals of the first mineralised ED concentrate stream of step b),
   optionally, one or more additional lactose-reduced liquids, preferably obtained during the method, and
   optionally, further ingredients,
wherein the lactose-reduced milk intermediate liquid of step d) comprises:
   the UF retentate in an amount of 30-80% w/w, more preferably 40-75% w/w, even more preferably 45-70% w/w, and most preferably 50-65% w/w, and
   the mineralised ED concentrate of step b) in an amount of 5-40% w/w, more preferably 10-40% w/w, even more preferably 10-35% w/w, and most preferably 12-35% w/w.

In some particularly preferred embodiments of the invention, the method comprises the steps of:
a) subjecting a milk feed to ultrafiltration (UF) to provide:
   a UF retentate enriched with respect to milk protein, and
   a UF permeate enriched with respect to lactose,
wherein the UF step is performed with a concentration factor of 1.2-20,
b) performing a first electrodialysis process using a diluate stream which comprises or even consists of:
   an NF retentate of a portion of the UF permeate
and using a concentrate stream which comprises, or even consists of:
   an NF permeate of a portion of the UF permeate,
to provide a first mineral-enriched ED concentrate stream,
wherein the concentrate stream of step b) has a conductivity of at least 1 mS/cm, and the diluate stream of step b) has a conductivity of at least 2 mS/cm,
and wherein the electrodialysis of step b) is operated to obtain a demineralisation rate of at least 60%,
d) preparing a lactose-reduced milk intermediate liquid by combining:
   the UF retentate,
   the first mineralised ED concentrate stream of step b), and
   optionally, further ingredients,
wherein the lactose-reduced milk intermediate liquid of step d) comprises:
   the UF retentate in an amount of 30-80% w/w, more preferably 40-75% w/w, even more preferably 45-70% w/w, and most preferably 50-65% w/w, and
   the mineralised ED concentrate of step b) in an amount of 5-40% w/w, more preferably 10-40% w/w, even more preferably 10-35% w/w, and most preferably 12-35% w/w.
e) further processing the lactose-reduced milk intermediate liquid of step d) by one or more of:
   i) lactose hydrolysis,
   ii) homogenization,
   iii) heat-treatment,
   iv) drying, and
   v) packaging.

In other particularly preferred embodiments of the invention, the method comprises the steps of:
a) subjecting a milk feed to ultrafiltration (UF) to provide:
   a UF retentate enriched with respect to milk protein, and
   a UF permeate enriched with respect to lactose,
Wherein the UF step is performed with a concentration factor of 1.2-20
b) performing a first electrodialysis process using a diluate stream which comprises or even consists of:
   a portion of the UF permeate, and/or
   a first lactose-enriched retentate derived from a portion of the UF permeate
and using a concentrate stream which comprises, or even consists of:
   a lactose-reduced liquid derived from a portion of the UF permeate,
to provide a first mineral-enriched ED concentrate stream,
wherein the concentrate stream of step b) has a conductivity of at least 1 mS/cm, and the diluate stream of step b) has a conductivity of at least 2 mS/cm,
and wherein the electrodialysis of step b) is operated to obtain a demineralisation rate of at least 60%,
d) preparing a lactose-reduced milk intermediate liquid by combining:
   a portion of the UF retentate, or a protein concentrate thereof,
   at least the minerals of the first mineralised ED concentrate stream of step b),
   optionally, one or more additional lactose-reduced liquids, preferably obtained during the method, and
   optionally, further ingredients,
wherein the lactose-reduced milk intermediate liquid of step d) comprises:
   the UF retentate in an amount of 30-80% w/w, more preferably 40-75% w/w, even more preferably 45-70% w/w, and most preferably 50-65% w/w, and
   the mineralised ED concentrate of step b) in an amount of 5-40% w/w, more preferably 10-40% w/w, even more preferably 10-35% w/w, and most preferably 12-35% w/w.
e) further processing the lactose-reduced milk intermediate liquid of step d) by one or more of:
   i) lactose hydrolysis,
   ii) homogenization,
   iii) heat-treatment,
   iv) drying, and
   v) packaging.

Yet an aspect of the invention pertains to a lactose-reduced milk product obtainable by the method described herein. Preferably, in the form of a liquid lactose-reduced milk product.

Preferably, at least 80% w/w of the solids of lactose-reduced milk product originates from the milk feed, more preferably at least 90% w/w, even more preferably at least 95% w/w, and most preferably at least 99% w/w.

Preferably, at least 80% w/w of the protein of lactose-reduced milk product originates from the milk feed, more preferably at least 90% w/w, even more preferably at least 95% w/w, and most preferably at least 99% w/w.

Preferably, at least 80% w/w of the mineral of lactose-reduced milk product originates from the milk feed, more preferably at least 90% w/w, even more preferably at least 95% w/w, and most preferably at least 99% w/w.

Preferably, at least 80% w/w of the water of lactose-reduced milk product originates from the milk feed, more preferably at least 90% w/w, even more preferably at least 95% w/w, and most preferably at least 99% w/w.

Preferably, the lactose-reduced milk product has a fat content of at most 4% w/w, more preferably at most 1% w/w, even more preferably 0.5% w/w, and most preferably 0.1% w/w.

In some preferred embodiments of the invention, the lactose-reduced milk product has a fat content of 0.001-4% w/w, more preferably 0.001-1% w/w, even more preferably 0.001-0.5% w/w, and most preferably 0.001-0.1% w/w.

Preferably, the lactose-reduced milk product has a lactose content of at most 3.8% w/w, more preferably at most 1% w/w, even more preferably at most 0.1% w/w, and most preferably at most 0.01% w/w.

Preferably, the lactose-reduced milk product has a combined content of glucose and galactose of 0-3.8% w/w, more preferably 0.5-3.8% w/w, even more preferably 1-3.8% w/w, and most preferably 2-3.8% w/w.

Preferably, the lactose-reduced milk product has a carbohydrate content of 0-12% w/w, more preferably 0.1-10% w/w, even more preferably 1-5% w/w, and most preferably 2.0-3.8% w/w.

Preferably, the lactose-reduced milk product has a protein content of 1-15% w/w, more preferably 2-10% w/w, even more preferably 3-8% w/w, and most preferably 3-4% w/w.

Preferably, the lactose-reduced milk product has a non-protein nitrogen content of 0.015-0.06%, more preferably 0.015-0.05% w/w, even more preferably 0.02-0.04% w/w, and most preferably 0.02-0.03% w/w.

Preferably, the lactose-reduced milk product has a pH in the range of 6-8, more preferably 6.0-8.0, even more preferably 6.2-7.8, and most preferably 6.4-7.5.

Preferably, the lactose-reduced milk product comprises the UF retentate, or a protein concentrate thereof, in an amount of 30-80% w/w, more preferably 40-75% w/w, even more preferably 45-70% w/w, and most preferably 50-65% w/w.

Preferably, the lactose-reduced milk product comprises the UF retentate in an amount of 30-80% w/w, more preferably 40-75% w/w, even more preferably 45-70% w/w, and most preferably 50-65% w/w.

Preferably, the lactose-reduced milk product comprises the mineralised ED concentrate(s) of step b) and/or c) in an amount of 5-40% w/w, more preferably 10-40% w/w, even more preferably 10-35% w/w, and most preferably 12-35% w/w.

It is particularly preferred that the lactose-reduced milk product is the lactose-reduced milk intermediate liquid which has been subjected to sub-step e.i) lactose hydrolysis, sub-step e.iii) heat treatment involving heat sterilisation, and sub-step e.v) packaging involving aseptic packaging, but not sub-step e.iv). The resulting packaged, liquid lactose-reduced milk product is sterile and has a shelf-life of at least 6 months at ambient storage.

In preferred embodiments of the invention, the lactose-reduced milk product has one or more of, more preferably two or more of, and most preferably all of:
a sodium content in the range of 0.035-0.06% w/w, and most preferably 0.04-0.05% w/w,
a potassium content in the range of 1.5-1.9% w/w, and most preferably 1.6-1.8% w/w,
a magnesium content in the range of 0.012-0.015% w/w, and most preferably 0.012-0.014% w/w
a calcium content in the range of 1.35-1.6% w/w, and most preferably 1.4-1.5% w/w,
a chloride content in the range of 0.94-1.2% w/w, and most preferably 0.96-1.1% w/w,
a phosphorus content in the range of 0.95-1.3% w/w, and most preferably 1.0-1.2% w/w, and
a non-protein-nitrogen content in the range of 0.019-0.05% w/w, and most preferably 0.019-0.04% w/w.

Without being bound by theory, the present inventors believe that the improved taste observed in relation to the present lactose-reduced milk product may be caused by the improved recovery of non-protein-nitrogen and minerals originating from the UF permeate. The inventors have furthermore seen that the present method also recovers a substantial portion of the small organic carboxylates, such as e.g. lactate and/or citrate, from the diluate stream which furthermore contributes to the sensory attributes of the lactose-reduced milk product.

In some preferred embodiments of the invention, the lactose-reduced milk product has one or more of, more preferably two or more of, and most preferably all of:
a protein content in the range of 3-10% w/w, and most preferably 3.5-9% w/w,
a fat content in the range of 0-4% w/w, and most preferably 0.01-2% w/w,
an ash content in the range of 0.65-1.5% w/w, and most preferably 0.70-1.3% w/w,
a lactose content in the range of at most 0.06% w/w, and most preferably at most 0.05% w/w,
a carbohydrate content of at most 5% w/w, and most preferably at most 3.8% w/w,
a pH in the range of 6.2-7.5, and most preferably 6.4-7.5.

In some preferred embodiments of the invention, the lactose-reduced milk product has one or more of, more preferably two or more of, and most preferably all of:
a protein content in the range of 3-5% w/w, and most preferably 3.5-4.0% w/w,
a fat content in the range of 0-4% w/w, and most preferably 0.01-2% w/w,
an ash content in the range of 0.65-1.0% w/w, and most preferably 0.70-0.9% w/w,
a lactose content of at most 0.06% w/w, and most preferably at most 0.05% w/w,
a carbohydrate content in the range of 1-5% w/w, and most preferably 2.0-3.8% w/w,
a pH in the range of 6.2-7.5, and most preferably 6.4-7.5.

In other preferred embodiments of the invention, the lactose-reduced milk product has one or more of, more preferably two or more of, and most preferably all of:
a protein content in the range of 6-10% w/w, and most preferably 7-9 w/w,
a fat content in the range of 0-4% w/w, and most preferably 0.01-2% w/w,
an ash content in the range of 0.65-1.5% w/w, and most preferably 0.9-1.3% w/w,
a lactose content of at most 0.06% w/w, and most preferably of at most 0.05% w/w,
a carbohydrate content in the range of 1-5% w/w, and most preferably 2.0-3.8% w/w,
a pH in the range of 6.2-7.5, and most preferably 6.4-7.5.

In some preferred embodiments of the invention, the lactose-reduced milk product has one or more of, more preferably two or more of, and most preferably all of:
a protein content in the range of 3-5% w/w, and most preferably 3.5-4.0% w/w,
a fat content in the range of 0-4% w/w, and most preferably 0.01-2% w/w,
an ash content in the range of 0.65-1.0% w/w, and most preferably 0.70-0.9% w/w,
a lactose content of at most 0.06% w/w, and most preferably at most 0.05% w/w,
a carbohydrate content of at most 1% w/w, and most preferably at most 0.2% w/w,
a pH in the range of 6.2-7.5, and most preferably 6.4-7.5,
a high intensity sweetener.

In other preferred embodiments of the invention, the lactose-reduced milk product has one or more of, more preferably two or more of, and most preferably all of:
a protein content in the range of 6-10% w/w, and most preferably 7-9 w/w,
a fat content in the range of 0-4% w/w, and most preferably 0.01-2% w/w,
an ash content in the range of 0.65-1.5% w/w, and most preferably 0.9-1.3% w/w,
a lactose content of at most 0.06% w/w, and most preferably of at most 0.05% w/w,
a carbohydrate content of at most 1% w/w, and most preferably at most 0.2% w/w,
a pH in the range of 6.2-7.5, and most preferably 6.4-7.5,
a high intensity sweetener.

Preferably, the lactose-reduced milk product has a total solids content in the range of 5-21% w/w, and most preferably 6-16% w/w.

Yet an aspect of the invention pertains to the use of, or a process that comprises using, electrodialysis for transferring minerals from a first liquid stream originating from a milk feed and containing dairy minerals to a second liquid stream originating from a milk feed, wherein the first liquid stream is used as diluate stream for the ED and the second liquid stream is used as concentrate stream for the ED.

Preferably, the first liquid stream has an ash value measured in % w/w that is higher than the second liquid stream.

Preferably, the first liquid stream has a lactose concentration measured in % w/w that is higher than the second liquid stream.

Preferably, at least the first liquid stream, and preferably both the first and second liquid stream, have been prepared from milk. More preferably, at least the first liquid stream, and preferably both the first and second liquid stream, originate from the same milk feed. It is even more preferred that at least the first liquid stream, and preferably both the first and second liquid stream, originate from UF permeate of the same milk feed.

The use may furthermore involve combining the solids of the mineralised second liquid stream with other liquids originating from the same milk feed to provide a lactose-reduced milk intermediate liquid as defined herein. Preferably, the use may furthermore involve combining the the mineralised second liquid stream with other liquids originating from the same milk feed to provide a lactose-reduced milk intermediate liquid as defined herein.

The use may furthermore involve subjecting the lactose-reduced milk intermediate liquid to processing as described herein to provide a lactose-reduced milk product as described herein.

The term “dairy minerals” pertains to minerals that have been prepared from milk.

As will be understood by the skilled person, the features and implementations described above in relation to the electrodialysis of step b) equally apply to the ED of the use or of the process of using.

Particularly preferred embodiments of the invention pertain to the use of, or a process that comprises using, electrodialysis for transferring minerals from a first liquid stream originating from a milk feed and containing dairy minerals to a second liquid stream originating from a milk feed, wherein the first liquid stream is used as diluate stream for the ED and the second liquid stream is used as concentrate stream for the ED, wherein the first and second liquid stream, originate from the same milk feed.

Other particularly preferred embodiments of the invention pertain to the use of, or a process that comprises using, electrodialysis for transferring minerals from a first liquid stream originating from a milk feed and containing dairy minerals to a second liquid stream originating from a milk feed, wherein the first liquid stream is used as diluate stream for the ED and the second liquid stream is used as concentrate stream for the ED, wherein the first and second liquid stream, originate from UF permeate of the same milk feed.

The inventors have found that the ED of the use, or the process of using, preferably furthermore transfers small charged organic molecules to the second liquid stream, such as e.g. deprotonated organic acids and nitrogen-containing small molecules that contribute to the NPN fraction of first liquid stream.

Features relating to the diluate stream of step b) equally apply to the first liquid stream of the use.

Features relating to the concentrate stream of step b) equally apply to the second liquid stream of the use.

Embodiments and preferences described in the context of the concentrate stream of step b) equally apply to the first liquid stream. Embodiments and preferences described in the context of the diluate stream of step b) equally apply to the second liquid stream. Embodiments and preferences described in the context of the ED of step b) equally apply to the ED of the above-mentioned use or process.

In the following, preferred numbered embodiments of the invention are described.

Numbered embodiment 1. A method of producing a lactose-reduced milk product, the method comprising the steps of:
a) subjecting a milk feed to ultrafiltration (UF) to provide:
   a UF retentate enriched with respect to milk protein, and
   a UF permeate enriched with respect to lactose,
b) performing a first electrodialysis process using a diluate stream which comprises or even consists of:
   a portion of the UF permeate, and/or
   a first lactose-enriched retentate derived from a portion of the UF permeate
and using a concentrate stream which comprises, or even consists of:
   a lactose-reduced liquid derived from a portion of the UF permeate,
to provide a first mineral-enriched ED concentrate stream,
c) optionally, performing one or more additional electrodialysis process(es) using diluate stream(s) comprising, or even consisting of:
   a portion of the UF permeate, and/or
   an additional lactose-enriched retentate derived from a portion of the UF permeate,
and using a concentrate stream comprising or even consisting of:
   the first mineral-enriched concentrate stream obtained from step b), and/or
   a further lactose-reduced liquid derived from a portion of the UF permeate,
to provide one or more additional mineral-enriched ED concentrate stream(s),
d) preparing a lactose-reduced milk intermediate liquid by combining:
   a portion of the UF retentate, or a protein concentrate thereof,
   one or more of:
      at least the minerals of the first mineralised ED concentrate stream of step b), and/or
      at least the minerals of one or more of the additional mineral-enriched ED concentrated stream(s) of step c)
   optionally, one or more additional lactose-reduced liquids, preferably obtained during the method, and
   optionally, further ingredients.

Numbered embodiment 2. The method according to numbered embodiment 1, furthermore comprising a step e) of further processing the lactose-reduced milk intermediate liquid of step d), preferably by one or more of:
i) lactose hydrolysis,
ii) homogenization,
iii) heat-treatment,
iv) drying, and
v) packaging.

Numbered embodiment 3. The method according to numbered embodiment 1 or 2 wherein the milk feed is selected from the group consisting of skimmed milk, semi-skimmed milk, and whole milk, or a protein concentrate thereof, or a dilution thereof.

Numbered embodiment 4. The method according to any of the preceding numbered embodiments, wherein the milk feed has a fat content of at most 4% w/w, more preferably at most 1% w/w, even more preferably at most 0.5% w/w, and most preferably at most 0.1% w/w.

Numbered embodiment 5. The method according to any of the preceding numbered embodiments, wherein the milk feed has a lactose content of 1-15%, more preferably 2-10% w/w, even more preferably 3-8% w/w, and most preferably 4-6% w/w.

Numbered embodiment 6. The method according to any of the preceding numbered embodiments, wherein the milk feed has a protein content of 1-15%, more preferably 2-10% w/w, even more preferably 3-8% w/w, and most preferably 3-4% w/w.

Numbered embodiment 7. The method according to any of the preceding numbered embodiments, wherein the milk feed has a non-protein nitrogen content of 0.01-0.06%, more preferably 0.015-0.05% w/w, even more preferably 0.02-0.04% w/w, and most preferably 0.02-0.03% w/w.

Numbered embodiment 8. The method according to any of the preceding numbered embodiments, wherein the milk feed has a pH in the range of 6-8, more preferably 6.0-8.0, even more preferably 6.2-7.8, and most preferably 6.4-7.2.

Numbered embodiment 9. The method according to any of the preceding numbered embodiments, wherein the UF membrane has nominal pore size in the range of 1000-50000 Da, more preferably 2000-40000 Da, even more preferably 3000-30000 Da, and most preferably 4000-30000 Da.

Numbered embodiment 10. The method according to any of the preceding numbered embodiments, wherein the UF step is performed with a concentration factor of 1.2-20, more preferably 1.5-10, even more preferably 1.7-8, and more preferably 1.8-5.

Numbered embodiment 11. The method according to any of the preceding numbered embodiments, wherein the UF step involves diafiltration, preferably using a lactose-reduced stream derived from a portion of the UF permeate or from the milk feed as diluent.

Numbered embodiment 12. The method according to any of the preceding numbered embodiments, wherein the ultrafiltration of step a) is operated at a temperature in the range of 0-60 degrees C., more preferably 2-50 degrees C., even more preferably 4-20 degrees C., and most preferably 5-15 degrees C.

Numbered embodiment 13. The method according to any of the preceding numbered embodiments, wherein the UF retentate has a protein content that is at least 20% higher than the protein content of the milk feed, more preferably at least 50% higher, even more preferably at least 70% higher, and most preferably at least 80% higher.

Numbered embodiment 14. The method according to any of the preceding numbered embodiments, wherein the sum of
the UF permeate, and
lactose-enriched retentate(s) derived from a portion of the UF permeate,
   makes up least 50% w/w of the diluate stream of step b), more preferably at least 70% w/w, even more preferably at least 80% w/w, and most preferably at least 90% w/w.

Numbered embodiment 15. The method according to any of the preceding numbered embodiments, wherein the sum of
the UF permeate, and
lactose-enriched retentate(s) derived from a portion of the UF permeate,
   makes up least 95% w/w of the diluate stream of step b), more preferably at least 97% w/w, even more preferably at least 99% w/w, and most preferably 100% w/w.

Numbered embodiment 16. The method according to any of the preceding numbered embodiments, wherein the first lactose-enriched retentate derived from a portion of the UF permeate is an NF retentate or an RO retentate.

Numbered embodiment 17. The method according to any of the preceding numbered embodiments, wherein the diluate stream of step b) has a pH in the range of 5-8, more preferably 5.2-7.6, even more preferably 5.4-7.0, and most preferably 5.8-6.6.

Numbered embodiment 18. The method according to any of the preceding numbered embodiments, wherein the concentrate stream of step b) comprises or even consists of an NF permeate or an RO permeate derived from of the UF permeate, preferably an NF permeate or an RO permeate of the UF permeate.

Numbered embodiment 19. The method according to any of the preceding numbered embodiments, wherein lactose-reduced stream(s) derived from a portion of the UF permeate makes up at least 50% w/w of the concentrate stream of step b), more preferably at least 70% w/w, even more preferably at least 80% w/w, and most preferably at least 90% w/w.

Numbered embodiment 20. The method according to any of the preceding numbered embodiments, wherein lactose-reduced stream(s) derived from a portion of the UF permeate makes up at least 95% w/w of the concentrate stream of step b), more preferably at least 97% w/w, even more preferably at least 99% w/w, and most preferably 100% w/w.

Numbered embodiment 21. The method according to any of the preceding numbered embodiments, wherein the concentrate stream of step b) has a pH in the range of 6-8, more preferably 6.0-8.0, even more preferably 6.2-7.8, and most preferably 6.4-7.2.

Numbered embodiment 22. The method according to any of the preceding numbered embodiments, wherein the electrodialysis of step b) is operated at a temperature in the range of 0-60 degrees C., more preferably 2-50 degrees C., even more preferably 4-20 degrees C., and most preferably 5-15 degrees C.

Numbered embodiment 23. The method according to any of the preceding numbered embodiments, wherein the electrodialysis of step b) is operated with a voltage per membrane pair in the range of 0.2-5 V, more preferably 0.4-3 V, even more preferably 0.6-2 V; and most preferably 0.8-1.8 V.

Numbered embodiment 24. The method according to any of the preceding numbered embodiments, wherein the electrodialysis of step b) is operated to obtain a demineralisation rate of at least 60% more preferably at least 80%, even more preferably at least 90%, and most preferably at least 95%.

Numbered embodiment 25. The method according to any of the preceding numbered embodiments, wherein at least 80% w/w of the solids of lactose-reduced milk intermediate liquid of step d) originate from the milk feed, more preferably at least 90% w/w, even more preferably at least 95% w/w, and most preferably at least 99% w/w.

Numbered embodiment 26. The method according to any of the preceding numbered embodiments, wherein at least 80% w/w of the protein of lactose-reduced milk intermediate liquid of step d) originate from the milk feed, more preferably at least 90% w/w, even more preferably at least 95% w/w, and most preferably at least 99% w/w.

Numbered embodiment 27. The method according to any of the preceding numbered embodiments, wherein at least 80% w/w of the mineral of lactose-reduced milk intermediate liquid of step d) originates from the milk feed, more preferably at least 90% w/w, even more preferably at least 95% w/w, and most preferably at least 99% w/w.

Numbered embodiment 28. The method according to any of the preceding numbered embodiments, wherein at least 80% w/w of the water of lactose-reduced milk intermediate liquid of step d) originates from the milk feed, more preferably at least 90% w/w, even more preferably at least 95% w/w, and most preferably at least 99% w/w.

Numbered embodiment 29. The method according to any of the preceding numbered embodiments, wherein the lactose-reduced milk intermediate liquid of step d) has a fat content of at most 4% w/w, more preferably at most 1% w/w, even more preferably at most 0.5% w/w, and most preferably at most 0.1% w/w.

Numbered embodiment 30. The method according to any of the preceding numbered embodiments, wherein the lactose-reduced milk intermediate liquid of step d) has a lactose content of at most 3.8% w/w, more preferably at most 1% w/w, even more preferably at most 0.01% w/w, and most preferably at most 0.001% w/w.

Numbered embodiment 31. The method according to any of the preceding numbered embodiments, wherein the lactose-reduced milk intermediate liquid of step d) has a combined content of lactose, glucose and galactose of 0-3.8%, more preferably 0.5-3.8% w/w, even more preferably 1-3.8% w/w, and most preferably 2-3.8% w/w.

Numbered embodiment 32. The method according to any of the preceding numbered embodiments, wherein the lactose-reduced milk intermediate liquid of step d) has a carbohydrate content of 0-12%, more preferably 0.1-10% w/w, even more preferably 1-5% w/w, and most preferably 2.0-3.8% w/w.

Numbered embodiment 33. The method according to any of the preceding numbered embodiments, wherein the lactose-reduced milk intermediate liquid of step d) has a protein content of 1-15%, more preferably 2-10% w/w, even more preferably 3-8% w/w, and most preferably 3-4% w/w.

Numbered embodiment 34. The method according to any of the preceding numbered embodiments, wherein the lactose-reduced milk intermediate liquid of step d) has a non-protein nitrogen content of 0.015-0.06%, more preferably 0.015-0.05% w/w, even more preferably 0.02-0.04% w/w, and most preferably 0.02-0.03% w/w.

Numbered embodiment 35. The method according to any of the preceding numbered embodiments, wherein the lactose-reduced milk intermediate liquid of step d) has a pH in the range of 6-8, more preferably 6.0-8.0, even more preferably 6.2-7.8, and most preferably 6.4-7.5.

Numbered embodiment 36. The method according to any of the preceding numbered embodiments, wherein the lactose-reduced milk intermediate liquid of step d) comprises the UF retentate, or a protein concentrate thereof, in an amount of 30-80% w/w, more preferably 40-75% w/w, even more preferably 45-70% w/w, and most preferably 50-65% w/w.

Numbered embodiment 37. The method according to any of the preceding numbered embodiments, wherein the lactose-reduced milk intermediate liquid of step d) comprises the UF retentate in an amount of 30-80% w/w, more preferably 40-75% w/w, even more preferably 45-70% w/w, and most preferably 50-65% w/w.

Numbered embodiment 38. The method according to any of the preceding numbered embodiments, wherein the lactose-reduced milk intermediate liquid of step d) comprises the mineralised ED concentrate(s) of step b) and/or c) in an amount of 5-40% w/w, more preferably 10-40% w/w, even more preferably 10-35% w/w, and most preferably 12-35% w/w.

Numbered embodiment 39. The method according to any of the preceding numbered embodiments, wherein the lactose-reduced milk intermediate liquid of step d) contains one or more of, and preferably all of:
At least 80% of the water of the milk feed, more preferably at least 90% w/w, and most preferably at least 95% w/w of the water of the milk feed,
At least 90% of the protein of the milk feed, more preferably at least 95% w/w, and most preferably at least 98% w/w of the protein of the milk feed,
At least 80% of the mineral of the milk feed, more preferably at least 90% w/w, and most preferably at least 95% w/w of the mineral of the milk feed,
At most 70% of the lactose of the milk feed, more preferably at most 50% w/w, and most preferably at most 20% w/w of the lactose of the milk feed.

Numbered embodiment 40. The method according to any one of numbered embodiments 2-38 wherein step e) comprises subjecting the lactose-reduced milk intermediate liquid of step d) to:
iii) heat-treatment, and
v) packaging.

Numbered embodiment 41. The method according to any one of numbered embodiments 2-38 wherein step e) comprises subjecting the lactose-reduced milk intermediate liquid of step d) to:
iii) heat-treatment,
iv) drying, and
v) packaging.

Numbered embodiment 42. The method according to any one of the preceding numbered embodiments wherein the ED stack used in step b) contains at least 5 cell pairs, more preferably at least 10 cell pairs, even more preferably at least 30 cell pairs and most preferably at least 100 cell pairs.

Numbered embodiment 43. The method according to any one of the preceding numbered embodiments wherein the ED stack used in step b) contains at least 30 cell pairs.

Numbered embodiment 44. The method according to any one of the preceding numbered embodiments wherein the ED system used in step b) contains 5-1000 cell pairs, more preferably 10-800 cell pairs, even more preferably 30-600 cell pairs and most preferably 100-500 cell pairs.

Numbered embodiment 45. A lactose-reduced milk product obtainable by a method according to one or more of numbered embodiment 1-44.

Numbered embodiment 46. The lactose-reduced milk product to according to numbered embodiment 45, wherein at least 80% w/w of the solids of lactose-reduced milk product originates from the milk feed, more preferably at least 90% w/w, even more preferably at least 95% w/w, and most preferably at least 99% w/w.

Numbered embodiment 47. The lactose-reduced milk product to according to numbered embodiment 45 or 46, wherein at least 80% w/w of the protein of lactose-reduced milk product originates from the milk feed, more preferably at least 90% w/w, even more preferably at least 95% w/w, and most preferably at least 99% w/w.

Numbered embodiment 48. The lactose-reduced milk product according to any of the numbered embodiments 45-47, wherein at least 80% w/w of the mineral of lactose-reduced milk product originates from the milk feed, more preferably at least 90% w/w, even more preferably at least 95% w/w, and most preferably at least 99% w/w.

Numbered embodiment 49. The lactose-reduced milk product according to any of the numbered embodiments 45-48, wherein at least 80% w/w of the water of lactose-reduced milk product originates from the milk feed, more preferably at least 90% w/w, even more preferably at least 95% w/w, and most preferably at least 99% w/w.

Numbered embodiment 50. The lactose-reduced milk product according to any of the numbered embodiments 45-49, wherein the lactose-reduced milk product has a fat content of at most 4% w/w, more preferably at most 1% w/w, even more preferably at most 0.5% w/w, and most preferably at most 0.1% w/w.

Numbered embodiment 51. The lactose-reduced milk product according to any of the numbered embodiments 45-50, wherein the lactose-reduced milk product has a fat content of 0.001-4% w/w, more preferably 0.001-1% w/w, even more preferably 0.001-0.5% w/w, and most preferably 0.001-0.1% w/w.

Numbered embodiment 52. The lactose-reduced milk product according to any of the numbered embodiments 45-51, wherein the lactose-reduced milk product has a lactose content of at most 0.5% w/w, more preferably 0.05% w/w, even more preferably at most 0.01% w/w, and most preferably at most 0.001% w/w.

Numbered embodiment 53. The lactose-reduced milk product according to any of the numbered embodiments 45-52, wherein the lactose-reduced milk product has a combined content of glucose and galactose of 0-3.8%, more preferably 0.5-3.8% w/w, even more preferably 1-3.8% w/w, and most preferably 2-3.8% w/w.

Numbered embodiment 54. The lactose-reduced milk product according to any of the numbered embodiments 45-53, wherein the lactose-reduced milk product has a carbohydrate content of 0-12%, more preferably 0.1-10% w/w, even more preferably 1-5% w/w, and most preferably 2.0-3.8% w/w.

Numbered embodiment 55. The lactose-reduced milk product according to any of the numbered embodiments 45-54, wherein the lactose-reduced milk product has a protein content of 1-15%, more preferably 2-10% w/w, even more preferably 3-8% w/w, and most preferably 3-4% w/w.

Numbered embodiment 56. The lactose-reduced milk product according to any of the numbered embodiments 45-55, wherein the lactose-reduced milk product has a non-protein nitrogen content of 0.015-0.06%, more preferably 0.015-0.05% w/w, even more preferably 0.02-0.04% w/w, and most preferably 0.02-0.03% w/w.

Numbered embodiment 57. The lactose-reduced milk product according to any of the numbered embodiments 45-56 wherein the lactose-reduced milk product has a pH in the range of 6-8, more preferably 6.0-8.0, even more preferably 6.2-7.8, and most preferably 6.4-7.5.

Numbered embodiment 58. The lactose-reduced milk product according to any of the numbered embodiments 45-57, wherein the lactose-reduced milk product comprises the UF retentate, or a protein concentrate thereof, in an amount of 30-80% w/w, more preferably 40-75% w/w, even more preferably 45-70% w/w, and most preferably 50-65% w/w.

Numbered embodiment 59. The lactose-reduced milk product according to any of the numbered embodiments 45-58, wherein the lactose-reduced milk product comprises the UF retentate in an amount of 30-80% w/w, more preferably 40-75% w/w, even more preferably 45-70% w/w, and most preferably 50-65% w/w.

Numbered embodiment 60. The lactose-reduced milk product according to any of the numbered embodiments 45-59, wherein the lactose-reduced milk product comprises the mineralised ED concentrate(s) of step b) and/or c) in an amount of 5-40% w/w, more preferably 10-40% w/w, even more preferably 10-35% w/w, and most preferably 12-35% w/w.

Numbered embodiment 61. The lactose-reduced milk product according to any of the numbered embodiments 45-60 having one or more of, more preferably two or more of, and most preferably all of:
a sodium content in the range of 0.035-0.06% w/w, and most preferably 0.04-0.05% w/w,
a potassium content in the range of 1.5-1.9% w/w, and most preferably 1.6-1.8% w/w,
a magnesium content in the range of 0.012-0.015% w/w, and most preferably 0.012-0.014% w/w
a calcium content in the range of 1.35-1.6% w/w, and most preferably 1.4-1.5% w/w,
a chloride content in the range of 0.94-1.2% w/w, and most preferably 0.96-1.1% w/w,
a phosphorus content in the range of 0.95-1.3% w/w, and most preferably 1.0-1.2% w/w, and
a non-protein-nitrogen content in the range of 0.019-0.05% w/w, and most preferably 0.019-0.04% w/w.

Numbered embodiment 62. The lactose-reduced milk product according to any of the numbered embodiments 45-61 having one or more of, more preferably two or more of, and most preferably all of:
a protein content in the range of 3-5% w/w, and most preferably 3.5-4.0% w/w,
a fat content in the range of 0-0.5% w/w, and most preferably 0.05-0.3% w/w,
an ash content in the range of 0.65-1.0% w/w, and most preferably 0.70-0.9% w/w,
a lactose content in the range of 0.001-0.06% w/w, and most preferably 0.001-0.05% w/w,
a carbohydrate content in the range of 1-5% w/w, and most preferably 2.0-3.8% w/w,
a pH in the range of 6.2-7.5, and most preferably 6.4-7.5.

The present invention has been described above with reference to specific embodiments. However, other embodiments than the above described are equally possible within the scope of the invention. The different features and steps of various embodiments and aspects of the invention may be combined in other ways than those described herein unless it is stated otherwise.

### EXAMPLES

### Example 1

### Process

Skim milk was ultrafiltered to a concentration factor (CF) of 2.0 using a UF unit equipped with spiral wound filtration elements (molecular weight cut off: 10000 Da). This process generated UF-retentate (UFR, 50% volume fraction of the starting skim milk) and UF-permeate (UFP, 50% volume fraction of the starting skim milk). All membrane filtrations were operated with liquid temperatures of at 10 degrees C. and the ED was operated with liquids (concentrate stream, diluate stream and electrolyte stream) having room temperature. For industrial implementation, however, it is preferred that the temperatures of all liquid will be at most 10 degrees C. and preferably below 10 degrees C.

The UF-permeate was then nanofiltered to a CF of 4.0 using a nanofiltration (NF) unit, equipped with spiral wound elements (molecular weight cut off: 200 Da). This process generated NF-retentate (NFR, 12.5% volume fraction of the skim milk) and NF-permeate (NFP, 37.5% volume fraction of the skim milk).

The NFR and NFP were processed with a laboratory scale electrodialysis (ED) unit. The ED process was performed with NFR as diluate (the stream subjected to mineral reduction) and NFP as concentrate (the stream which received minerals from the diluate stream). The ED process was carried out with 2.5 Kg of diluate (NFR) and 2.5 Kg concentrate (NFP) at a constant DC voltage of 1.5V/cell pair.

The ED unit with a module (EDR-Z/2×10-0.8) with 10 membrane cell pairs from MemBrain (Stráž pod Ralskem, Czech Republic) was used. The effective surface area of one membrane was 64 cm2. The membranes used in the ED module were heterogeneous anion-exchange membranes (AEM, RALEX® AMH-PES) and cation-exchange membranes (CEM, RALEX®, CMH-PES).

### Analyses

The pH and electrical conductivity were measured inline during ED. The demineralisation rate (DMR) of the diluate solutions were determined using the equation:

$$DME = ( {EC}_{I} - {EC}_{T} ) / ( {EC}_{I} ) \times 100$$

Where, EC_{I} and EC_{T} are electrical conductivity before ED and after ED.

The ED process was run to reach the demineralisation rates of the UFP and NFR solutions of 70 to 99%.

Protein, fat, ash, non-protein nitrogen (NPN), lactose, minerals (Ca, P, K, Na, Mg, Cl) and total solids content of different samples produced for various examples were analysed at Eurofins Steins Laboratory (Vejen, Denmark) using the methods as listed in the Table 1 unless stated.

TABLE 1
Methods of analysis

| Compounds | Methods |
|---|---|
| Protein | Kjeldahl (ISO 8968-1: 2014/IDF 20-1) |
| Fat | Gravimetric by Rose Gottlieb (ISO 1211: 2010/IDF 1) |
| Total solids | Gravimetric (ISO 6731: 2010/IDF 21) |
| Ash | Gravimetric (NMKL 173: 2005) |
| Non-protein nitrogen (NPN) | Kjeldahl (ISO 8968-4: 2016/IDF 20-4) |
| Lactose | HPAEC-PAD (AOAC 982.14) |
| Calcium (Ca) | ICP-OES (DS/EN ISO 11885m: 2009) |
| Phosphorous (P) | ICP-OES (DS/EN ISO 11885m: 2009) |
| Potassium (K) | ICP-OES (DS/EN ISO 11885m: 2009) |
| Sodium (Na) | ICP-OES (DS/EN ISO 11885m: 2009) |
| Magnesium (Mg) | ICP-OES (DS/EN ISO 11885m: 2009) |
| Chloride (Cl) | Titrimetric (NMKL 178: 2004) |

The pH and conductivity measurements are normalised to 25 degrees C.

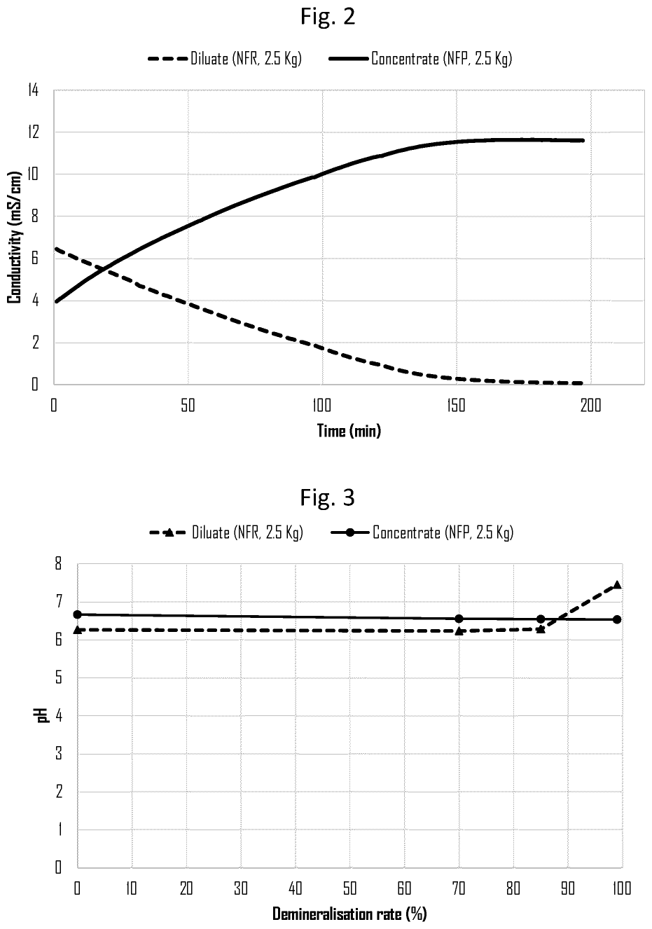

The electrical conductivity measurement is an estimation of the concentration of soluble salt or minerals fraction in a solution. The electrical conductivity value of diluate (NFR) decreased and increased for concentrate (NFP) due to the migration of minerals and to some extent of NPN and proteins from the diluate to concentrate stream during the ED process. When the demineralisation rate (DMR) of diluate approaches 85%, the change in the conductivity (i.e. migration of minerals) started to slow down (FIG. 2), but, it was possible to achieve the demineralisation rate of 99%.

The protein, NPN and mineral contents increased with the increase in the demineralisation rates (Table 2). Most importantly, when DMR of 99% was reached, the mineral concentration in the diluate (NFR) decreased significantly reaching the levels below the detection limit of the equipment. The pH of the concentrate solutions did not change even after 99% DMR. Consequently, the total solids of the concentrate increased from 0.2 to more 1.787%. However, for diluate solution, the pH started to increase slightly after 85% demineralisation rate reaching to a pH of 7.52 after 99% demineralisation.

In addition, a small amount of water (about 8% of the initial volume) can migrate to the concentrate stream from the diluate stream. This is due to the phenomenon called electro-osmosis. This is indeed beneficial as it leads to a decrease in the volume of the side stream (the diluate stream) and therefore an improved utilization of the original milk feed.

TABLE 2
The composition of diluate (NFR) and concentrate (NFP) before and
after ED process using equal volume of diluate and concentrate.

| | | | | Values after ED process | | | |
|---|---|---|---|---|---|---|---|
| | | Values before | | NFR | NFP | | |
| | | ED process | | 99% | 70% | 85% | 99% |
| Components | Units | NFR | NFP | DMR | DMR | DMR | DMR |
| Protein | g/100 g | 0.420 | <0.1 | 0.215 | 0.120 | 0.130 | 0.155 |
| Fat | | <0.02 | <0.02 | <0.02 | <0.02 | 0.030 | 0.020 |
| Ash | | 1.130 | 0.155 | <0.05 | 0.720 | 0.840 | 0.955 |
| NPN | | 0.054 | 0.011 | 0.0345 | 0.015 | 0.017 | 0.019 |
| Lactose | | 15.400 | <0.04 | 16.1 | <0.04 | 0.040 | 0.100 |
| Total solids | | 17.740 | 0.205 | 16.87 | 1.050 | 1.320 | 1.775 |
| Ca | mg/Kg | 1150 | <30 | 132 | 435 | 510 | 720 |
| P | | 1450 | <30 | 195 | 550 | 705 | 1000 |
| K | | 3400 | 663 | <100 | 2800 | 2950 | 3300 |
| Na | | 680 | 177 | <10 | 600 | 670 | 850 |
| Mg | | 230 | <10 | <10 | 78 | 98 | 170 |
| Cl | | 770 | 903 | <500 | 1855 | 1460 | 1330 |
| pH | | 6.29 | 6.77 | 7.52 | 6.73 | 6.70 | 6.70 |

### Example 2

The process used for example 2 is similar to that of example 1, except for the volume of the diluate and concentrate solutions used during the ED process. The ED process was performed with 2 Kg of NFR as diluate and 6 Kg of NFP as concentrate to simulate the generated volumes of NFR and NFP from the membrane filtration in example 1.

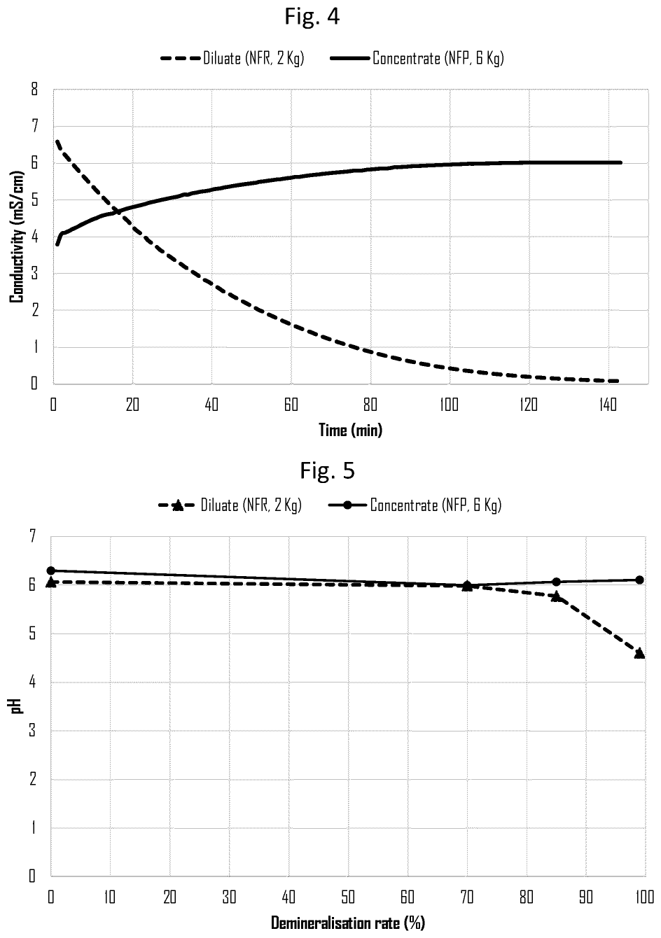

Using this ED set up, the demineralisation process was faster than the set up used in the example 1. The 99% demineralisation rate was achieved within 143 min compared to 200 min using the set up in the example 1 (see FIG. 4). In addition, pH of the concentrate stream did not change significantly except for the diluate stream which decreased after reaching the DMR of 85% (FIG. 5).

### Example 3

The process for example 3 is similar to that of example 1, except for the type of diluate and concentrate solutions used for the ED process. In this example, the UFP was used as diluate and NFP as concentrate streams. The ED process was performed with 2.5 Kg of the UF permeate (UFP) as diluate and 2.5 Kg of NFP as concentrate.

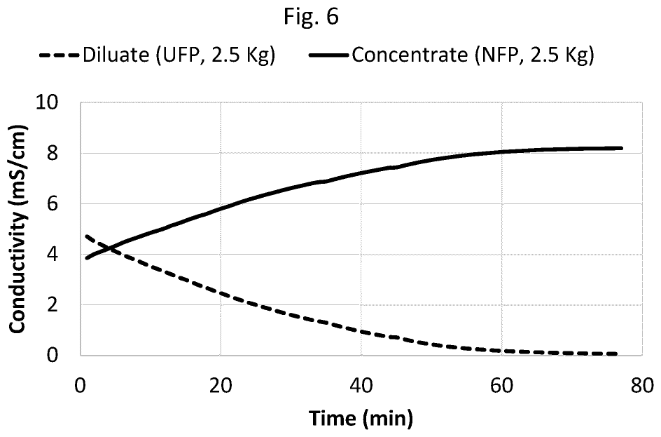

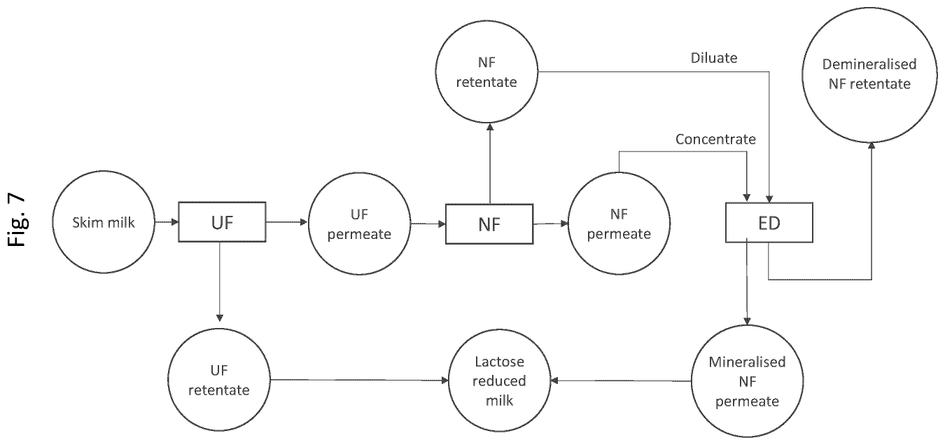

The electrical conductivity of the UFP (before ED) was lower than that of NFR (FIG. 6). It was possible to reach the demineralisation rate of 99% within 77 minutes, faster than using the set up in examples 1 and 2. The protein, NPN, ash (mineral) content, total solids contents of UFP were significantly lower compared to NFR. Even though, the concentration of protein and NPN was found to decrease slightly in the diluate (UFP) after ED process, no significant difference was observed in the concentrate side (Table 3). However, the mineral concentration in the diluate stream decreased considerably reaching values below the detection level which was recovered in the concentrate side.

TABLE 3
The composition of diluate (UFP) and concentrate
(NFP) before and after ED process.

| | | | | Values after | |
|---|---|---|---|---|---|
| | | | | ED process | |
| | | Values before | | UFP | NFP |
| | | ED process | | 99% | 99% |
| Components | Units | UFP | NFP | DMR | DMR |
| Protein | g/100 g | 0.160 | <0.1 | 0.110 | <0.01 |
| Fat | | 0.050 | <0.02 | 0.020 | 0.02 |
| Ash | | 0.260 | 0.155 | <0.05 | 0.47 |
| NPN | | 0.023 | 0.011 | 0.017 | 0.008 |
| Lactose | | 3.730 | <0.04 | 3.730 | <0.04 |
| Total solids | | 4.530 | 0.205 | 4.040 | 0.66 |
| Ca | mg/Kg | 270 | <30 | <30 | 240 |
| P | | 310 | <30 | <30 | 160 |
| K | | 1200 | 663 | <100 | 1700 |
| Na | | 330 | 177 | <10 | 530 |
| Mg | | 63 | <10 | <10 | 40 |
| Cl | | 850 | 903 | <500 | 1590 |
| pH | | 6.78 | 6.78 | 6.14 | 7.00 |

### Example 4

2 Kg of UFR (corresponding to 50% of the volume of the starting skim milk used) produced in example 1 was mixed with 1.5 Kg of ED mineralised NFP from example 2 (corresponding to the 37.5% of the starting skim milk used) to produce an ED-mineralized, lactose-reduced milk. Lactase could have been added to the ED-mineralized, lactose-reduced milk to bring the content of lactose below 0.01% w/w.

The differences in terms of physicochemical properties and composition of ED mineralized, lactose-reduced milk relative to a commercial lactose-free milk and skim milk were determined as described herein and are summarised in the table 4. The composition of the products were measured using MilkoScan™ FT1 (Foss Electric, Hillerød, Denmark).

TABLE 4
The composition, pH and electrical conductivity values of
ED mineralised, lactose reduced milk, standard lactose reduced
milk, commercial lactose free milk, and commercial skim milk
and ED mineralised lactose reduced milk samples.

| | ED mineralised | Commercial | |
|---|---|---|---|
| | lactose reduced | lactose free | Commercial |
| Properties | milk | milk | skim milk |
| pH | 6.56 | 6.89 | 6.72 |
| Conductivity | 5.37 | 4.44 | 5.1 |
| (mS/cm) | | | |
| Fat | 0.21 | 0.46 | 0.06 |
| Protein | 3.8 | 3.71 | 3.73 |
| Lactose | 2.93 | N.D | 4.93 |
| Dry matter | 7.6 | 7.37 | 9.54 |

N. D: not detectable.

The ED mineralised lactose-reduced milk was found to have a higher conductivity than the commercial lactose-free milk (produced without ED mineralisation) and even a higher conductivity than regular skim milk. The ED mineralised lactose-reduced milk was subjected to sensory testing and was found to have a better sensory performance than traditional lactose-free milk (produced by UF/NF-filtration and lactose hydrolysis) and had a pleasant, milky taste with a good mouthfeel. Without being bound by theory, the present inventors believe that the improved taste observed in relation to the present lactose-reduced milk product may be caused by the improved recovery of non-protein-nitrogen and minerals originating from the UF permeate. The inventors have furthermore seen that the present method also recovers a substantial portion of the small organic carboxylates, such as e.g. lactate or citrate, from the UF permeate which furthermore contributes to the sensory attributes of the lactose-reduced milk product.

Similar results were obtained when Example 1 and Example 4 were repeated in large scale.

### Example 5

The concentrations of the different components in the standard and ED mineralised lactose reduced milk samples were theoretically estimated by mixing the UFR and NFP (with and without ED) produced in the example 1.

The values were estimated by mixing a fraction of UFR (50% of the starting skim milk) with NFP (37.5% of the starting skim milk). The NFP with and without ED process was mixed with the UFR to make standard lactose reduced milk and the mineralised lactose reduced milk products, respectively. The estimated composition of lactose reduced milk samples with and without ED treatment is summarised in the table 5. The table shows that the mineral (ash) content of the milk product could be improved considerably by reaching the values closer to the skim milk (sample from another batch).

TABLE 5
The composition of UF retentate, standard lactose reduced
milk and ED mineralised lactose reduced milk samples.

| | | | | ED mineralised | |
|---|---|---|---|---|---|
| | | | Standard lactose- | lactose | Skim |
| Components | Units | UF retentate | reduced milk | reduced milk | milk |
| Protein | g/100 g | 6.46 | 3.734* | 3.742 | 3.6 |
| Fat | | 0.44 | 0.260* | 0.260 | 0.05 |
| Ash | | 0.94 | 0.604 | 0.718 | 0.8 |
| NPN | | 0.023 | 0.018 | 0.019 | 0.027 |
| Lactose | | 4.47 | 2.571* | 2.580 | 4.55 |
| Total solids | | 12.86 | 7.436 | 7.661 | 9.3 |
| Ca | mg/Kg | 2300 | 1327* | 1426 | 1300 |
| P | | 1600 | 927* | 1066 | 1100 |
| K | | 1900 | 1370 | 1747 | 1700 |
| Na | | 450 | 333 | 429 | 370 |
| Mg | | 180 | 107* | 130 | 120 |
| CI | | 930 | 918 | 979 | 1000 |

*maximum estimated value.

The liquid streams have a pH of approx. 6.6.

Lactase can be added to the ED-mineralized, lactose-reduced milk to bring the content of lactose below 0.01% w/w.

1-28. (canceled)

29. A method of producing a lactose-reduced milk product, the method comprising the steps of:
a) subjecting a milk feed to ultrafiltration (UF) to provide:
a UF retentate enriched with respect to milk protein, and
a UF permeate enriched with respect to lactose,
b) performing a first electrodialysis (ED) process using a diluate stream which comprises or even consists of:
a portion of the UF permeate, and/or
a first lactose-enriched retentate derived from a portion of the UF permeate
and using a concentrate stream which comprises, or even consists of:
a lactose-reduced liquid derived from a portion of the UF permeate,
to provide a first mineral-enriched ED concentrate stream,
and wherein the ED stack used in step b) contains at least 30 cell pairs,
c) optionally, performing one or more additional electrodialysis process(es) using diluate stream(s) comprising, or even consisting of:
a portion of the UF permeate, and/or
an additional lactose-enriched retentate derived from a portion of the UF permeate,
and using a concentrate stream comprising or even consisting of:
the first mineral-enriched concentrate stream obtained from step b), and/or
a further lactose-reduced liquid derived from a portion of the UF permeate,
to provide one or more additional mineral-enriched ED concentrate stream(s),
d) preparing a lactose-reduced milk intermediate liquid by combining:
a portion of the UF retentate, or a protein concentrate thereof,
one or more of:
at least the minerals of the first mineralised ED concentrate stream of step b), and/or
at least the minerals of one or more of the additional mineral-enriched ED concentrated stream(s) of step c)
optionally, one or more additional lactose-reduced liquids, preferably obtained during the method, and
optionally, further ingredients.

30. The method according to claim 29, furthermore comprising a step e) of further processing the lactose-reduced milk intermediate liquid of step d),

31. The method according to claim 30, wherein the further processing the lactose-reduced milk intermediate liquid of step d) involves one or more of:
i) lactose hydrolysis,
ii) homogenization,
iii) heat-treatment,
iv) drying, and
v) packaging.

32. The method according to claim 29, wherein the milk feed is selected from the group consisting of skimmed milk, semi-skimmed milk, and whole milk, or a protein concentrate thereof, or a dilution thereof.

33. The method according to claim 29, wherein the UF retentate has a protein content that is at least 20% higher than the protein content of the milk feed.

34. The method according to claim 29, wherein the sum of
the UF permeate, and
lactose-enriched retentate(s) derived from a portion of the UF permeate,
makes up least 50% w/w of the diluate stream of step b).

35. The method according to claim 29, wherein the first lactose-enriched retentate derived from a portion of the UF permeate is an NF retentate or an RO retentate.

36. The method according to claim 29, wherein the concentrate stream of step b) comprises or even consists of an NF permeate or an RO permeate derived from of the UF permeate, preferably an NF permeate or an RO permeate of the UF permeate.

37. The method according to claim 29, wherein lactose-reduced stream(s) derived from a portion of the UF permeate make up at least 50% w/w of the concentrate stream of step b).

38. The method according to claim 29, wherein the electrodialysis of step b) is operated to obtain a demineralisation rate of at least 60%.

39. The method according to claim 29, wherein:
at least 80% w/w of the solids of lactose-reduced milk intermediate liquid of step d) originates from the milk feed, and/or
at least 80% w/w of the mineral of lactose-reduced milk intermediate liquid of step d) originates from the milk feed.

40. The method according to claim 29, wherein at least 80% w/w of the water of lactose-reduced milk intermediate liquid of step d) originates from the milk feed.

41. The method according to claim 29, wherein the lactose-reduced milk intermediate liquid of step d) has one or more of:
a fat content of at most 4% w/w,
a lactose content of at most 3.8% w/w,
a protein content of 1-15%,
a non-protein nitrogen content of 0.015-0.06%, and
a pH in the range of 6-8.

42. The method according to claim 29, wherein the lactose-reduced milk intermediate liquid of step d) comprises one or more of:
the UF retentate, or a protein concentrate thereof, in an amount of 30-80% w/w, and
the mineralised ED concentrate(s) of step b) and/or c) in an amount of 5-40% w/w.

43. The method according to claim 29, wherein the ED stack used in step b) contains at least 100 cell pairs.

44. The method according to claim 29, wherein the ED system used in step b) contains 30-1000 cell pairs.

45. The method according to claim 29, wherein at least 80% w/w of the solids of lactose-reduced milk product originates from the milk feed.

46. The method according to claim 29, wherein at least 80% w/w of the protein of lactose-reduced milk product originates from the milk feed.

47. The method according to claim 29, wherein at least 80% w/w of the mineral of lactose-reduced milk product originates from the milk feed.

48. The method according to claim 29, wherein at least 80% w/w of the water of lactose-reduced milk product originates from the milk feed.

49. The method according to claim 29, wherein the lactose-reduced milk product has one or more of:
a fat content of at most 4% w/w,
a lactose content of at most 3.8% w/w,
a protein content of 1-15%,
a non-protein nitrogen content of 0.015-0.06%, and
a pH in the range of 6-8.

50. A lactose-reduced milk product obtainable by a method according to claim 29, the lactose-reduced milk product having:
a fat content of at most 4% w/w,
a lactose content of at most 3.8% w/w,
a protein content of 1-15,
a non-protein nitrogen content of 0.015-0.06%, and
a pH in the range of 6-8.

51. The lactose-reduced milk product according claim 50 having one or more of:
a sodium content in the range of 0.035-0.06% w/w,
a potassium content in the range of 1.5-1.9% w/w,
a magnesium content in the range of 0.012-0.015% w/w,
a calcium content in the range of 1.35-1.6% w/w,
a chloride content in the range of 0.94-1.2% w/w,
a phosphorus content in the range of 0.95-1.3% w/w, and
a non-protein-nitrogen content in the range of 0.019-0.05% w/w.

52. A method of using electrodialysis for transferring minerals from a first liquid stream to a second liquid stream, the method comprising:
a) providing a first liquid stream originating from a milk feed, said first liquid stream containing dairy minerals and serving as a diluate stream in an electrodialysis process,
b) providing a second liquid stream originating from a milk feed, said second liquid stream serving as a concentrate stream in the electrodialysis process,
c) performing electrodialysis on the first and second liquid streams using an electrodialysis stack containing at least 30 cell pairs, wherein the electrodialysis transfers minerals from the first liquid stream to the second liquid stream to mineralize the second liquid stream.

53. The method according to claim 52, wherein the first and second liquid stream, originate from the same milk feed.

54. The method according to claim 52, wherein the first and second liquid stream, originate from UF permeate of the same milk feed.

55. The method according to claim 52, wherein the first liquid stream has an ash value measured in % w/w that is higher than the ash value of the second liquid stream.

56. The method according to claim 52, wherein the first liquid stream has a lactose concentration measured in % w/w that is higher than lactose concentration of the second liquid stream.

57. The method according to claim 52, further comprising combining the solids of the mineralised second liquid stream, and preferably the mineralised second liquid stream as such, with other liquids originating from the same milk feed to provide a lactose-reduced milk intermediate liquid which preferably has one or more of:
a fat content of at most 4% w/w,
a lactose content of at most 3.8% w/w,
a protein content of 1-15%,
a non-protein nitrogen content of 0.015-0.06%, and
a pH in the range of 6-8.

58. The method according to claim 57, further involving subjecting the lactose-reduced milk intermediate liquid to processing involving one or more of:
i) lactose hydrolysis,
ii) homogenization,
iii) heat-treatment,
iv) drying, and
v) packaging.
